(19) United States
(12) Patent Application Publication
(10) Pub. No.: US 2026/0093840 A1
(43) Pub. Date: Apr. 2, 2026

(54) ROLE-BASED ACCESS CONTROL SYSTEMS FILTERING ACCESS TO PERMISSIONS FOR A DOMAIN

(71) Applicant: Truist Bank, Charlotte, NC (US)

(72) Inventors: Krishnaveni Kavuri, Waxhaw, NC (US); Chandra Sekhar Kapireddy, Waxhaw, NC (US); Kenneth William Cluff, Powhatan, VA (US); Thomas John Mazzaferro, Charlotte, NC (US); Sasipreetam Morsa, Irving, TX (US)

(73) Assignee: Truist Bank, Charlotte, NC (US)

(21) Appl. No.: 19/174,329

(22) Filed: Apr. 9, 2025

Related U.S. Application Data
(60) Provisional application No. 63/701,161, filed on Sep. 30, 2024.
(60) Provisional application No. 63/701,159, filed on Sep. 30, 2024.

(51) Int. Cl. G06F 21/62

(52) U.S. Cl. CPC G06F 21/6218

(57) ABSTRACT

Systems and methods receive an access request for a knowledge domain framework for generative AI model development, the access request including user credentials, and filter, based on the user credentials being authenticated, permissions defining a user-specific access level for utilizing the knowledge domain framework. Display of a user interface that includes prompts facilitating inputs to the knowledge domain framework is initiated, the prompts being regulated based on the permissions. Information to establish a desired knowledge domain is received from a user device associated with the user interface, the desired knowledge domain including a corpus of selected documents, and an indication of a type of a generative artificial intelligence model to be developed is received from the user device. Display of a prompt template for receiving user inputs and providing generative outputs is initiated, and text submission(s) are received. Response(s) to the text submission(s) are generated.

### CROSS REFERENCE TO RELATED APPLICATIONS

This application claims priority to and benefit of U.S. Provisional Patent Application No. 63/701,161 filed on Sep. 30, 2024, entitled FILTERED KNOWLEDGE DOMAIN MANAGEMENT AND CUSTOM GENERATIVE AI MODEL DEVELOPMENT FOR SIMULATION, and claims priority to of U.S. Provisional Patent Application No. 63/701,159 filed on Sep. 30, 2024, entitled CUSTOMIZED KNOWLEDGE DOMAIN FRAMEWORK SYSTEMS FOR GENERATIVE ARTIFICIAL INTELLIGENCE MODEL DESIGN AND AGENTIC LARGE LANGUAGE MODEL GENERATION, the entire contents of each of which are hereby expressly incorporated by reference.

### TECHNICAL FIELD

The present invention relates generally to the field of artificial intelligence model design; and more particularly, embodiments of the invention relate to filtered knowledge domain access and customized generative AI model development.

### BACKGROUND OF THE INVENTION

Technology is rapidly advancing in ways that challenge organizations to scale up their technology capabilities. The amount of time and resources organizations invest in technology development and design are significant. In particular, for software development within an organization, the organization may struggle to fully harness software development technology at a scale that would satisfy all of the needs of the organization. Often, organizations try to prioritize software development projects and processes that are in greatest need for the organization based on the most immediate financial benefit to the organization or due to market demand. However, there may be many advancements that are often deprioritized that could enhance the capabilities of the organization, the employee morale, the organizational efficiencies, and help set the organization apart as being more technologically advanced for the consumers. Thus, a need exists for processes that can implement advances in software development at scale across an organization.

### SUMMARY

Shortcomings of the prior art are overcome, and additional advantages are provided through the provision of a computing system for knowledge domain management for generative AI model development. The system includes at least one processor, a communication interface communicatively coupled to the at least one processor, and one or more memory devices storing executable code. Execution of the executable code causes the at least one processor to, at least in part, receive an access request for a knowledge domain framework for generative AI model development, the access request including user credentials, and filter, based on the user credentials being authenticated, permissions defining a user-specific access level for utilizing the knowledge domain framework. The system also initiates display of a user interface that includes prompts facilitating inputs to the knowledge domain framework, the prompts being regulated based on the permissions. In addition, the system receives, from a user device associated with the user interface, information to establish a desired knowledge domain, the desired knowledge domain including a corpus of selected documents and receives, from the user device, an indication of a type of a generative artificial intelligence model to be developed. Display, via the user interface, of a prompt template for receiving user inputs and providing generative outputs is initiated, and the system receives, via the prompt template, one or more text submissions and based thereon generate one or more responses to the one or more text submissions.

Additionally, disclosed herein is a computing system that includes at least one processor, a communication interface communicatively coupled to the at least one processor, and a memory device storing executable code that, when executed, causes the at least one processor to, at least in part, initiate display, via a user device, a user interface that includes prompts facilitating inputs to a knowledge domain framework, the prompts being regulated based on user permissions. The system also receives, from the user device, information to establish a desired knowledge domain, the desired knowledge domain including a corpus of selected documents. Further, the system receives, from the user device, an indication of a type of a generative artificial intelligence model to be developed, and initiates display, via the user interface, of a prompt template for receiving user inputs and providing generative outputs. In addition, the system receives, via the prompt template, one or more text submissions and based thereon generate one or more responses to the one or more text submissions.

Also disclosed herein is a computer-implemented method that includes, at least in part, receiving an access request for a knowledge domain framework for generative AI model development, the access request including user credentials. The method also includes filtering, based on the user credentials being authenticated, permissions defining a user-specific access level for utilizing the knowledge domain framework. Further, the method includes initiating display of a user interface that includes prompts facilitating inputs to the knowledge domain framework, the prompts being regulated based on the permissions. Information to establish a desired knowledge domain is received from a user device associated with the user interface, and the desired knowledge domain includes a corpus of selected documents. In addition, the method includes receiving, from the user device, an indication of a type of a generative artificial intelligence model to be developed, and the method also includes initiating display, via the user interface, of a prompt template for receiving user inputs and providing generative outputs. One or more text submissions are received via the prompt template, and based thereon the method also generates one or more responses to the one or more text submissions.

The features, functions, and advantages that have been described herein may be achieved independently in various embodiments of the present invention including computer-implemented methods, computer program products, and computing systems or may be combined in yet other embodiments, further details of which can be seen with reference to the following description and drawings.

### BRIEF DESCRIPTION OF THE DRAWINGS

One or more aspects are particularly pointed out and distinctly claimed as examples in the claims at the conclusion of the specification. The foregoing as well as objects, features, and advantages of one or more aspects are apparent from the following detailed description taken in conjunction with the accompanying drawings in which:

FIG. 1 illustrates an example computing environment of a computing system, in accordance with an embodiment of the present invention;

FIG. 2A is a diagram of a feedforward network, according to at least one embodiment, utilized in machine learning;

FIG. 2B is a diagram of a convolution neural network, according to at least one embodiment, utilized in machine learning;

FIG. 2C is a diagram of a portion of the convolution neural network of FIG. 2B, according to at least one embodiment, illustrating assigned weights at connections or neurons;

FIG. 3 is a diagram representing an exemplary weighted sum computation in a node in an artificial neural network;

FIG. 4 is a diagram of a Recurrent Neural Network RNN, according to at least one embodiment, utilized in machine learning;

FIG. 5 is a schematic logic diagram of an artificial intelligence program including a front-end and a back-end algorithm;

FIG. 6 is a flow chart representing a method, according to at least one embodiment, of model development and deployment by machine learning;

FIG. 6 is a flow chart representing a method, according to at least one embodiment, of model development and deployment by machine learning;

FIG. 7 depicts an example customized knowledge domain framework, according to one embodiment;

FIG. 8 depicts an example schematic for AI model development, in accordance with an embodiment of the present invention;

FIG. 9 depicts a block diagram of an example method, in accordance with an embodiment of the present invention;

FIG. 10 depicts a block diagram of an example method, in accordance with an embodiment of the present invention;

FIG. 11 depicts a block diagram of an example method, in accordance with an embodiment of the present invention; and

FIG. 12 depicts a block diagram of an example method, in accordance with an embodiment of the present invention.

### DETAILED DESCRIPTION

Aspects of the present invention and certain features, advantages, and details thereof are explained more fully below with reference to the non-limiting examples illustrated in the accompanying drawings. It is to be understood that the disclosed embodiments are merely illustrative of the present invention and the invention may take various forms. Further, the figures are not necessarily drawn to scale, as some features may be exaggerated to show details of particular components. Thus, specific structural and functional details illustrated herein are not to be interpreted as limiting, but merely as a representative basis for teaching one skilled in the art to employ the present invention.

Unless described or implied as exclusive alternatives, features throughout the drawings and descriptions should be taken as cumulative, such that features expressly associated with some particular embodiments can be combined with other embodiments.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the herein described embodiments can be configured without departing from the scope and spirit of the invention. Therefore, it is to be understood that, within the scope of the included claims, the invention may be practiced other than as specifically described herein.

Like numbers refer to like elements throughout. Unless defined otherwise, technical and scientific terms used herein have the same meaning as commonly understood to one of ordinary skill in the art to which the presently disclosed subject matter pertains.

Additionally, illustrative embodiments are described below using specific code, designs, architectures, protocols, layouts, schematics, or tools only as examples, and not by way of limitation. Furthermore, the illustrative embodiments are described in certain instances using particular software, tools, or data processing environments only as example for clarity of description. The illustrative embodiments can be used in conjunction with other comparable or similarly purposed structures, systems, applications, or architectures. One or more aspects of an illustrative embodiment can be implemented in hardware, software, or a combination thereof.

As understood by one skilled in the art, program code, as referred to in this application, can include both software and hardware. For example, program code in certain embodiments of the present invention can include fixed function hardware, while other embodiments can utilize a software-based implementation of the functionality described. Certain embodiments combine both types of program code.

The specification may include references to “one embodiment,” “an embodiment,” “various embodiments,” “one or more embodiments,” etc. may indicate that the embodiment(s) described may include a particular feature, structure or characteristic, but every embodiment may not necessarily include the particular feature, structure, or characteristic. In some cases, such phrases are not necessarily referencing the same embodiment. When a particular feature, structure, or characteristic is described in connection with an embodiment, such description can be combined with features, structures, or characteristics described in connection with other embodiments, regardless of whether such combinations are explicitly described. Furthermore, a device or structure that is configured in a certain way is configured in at least that way but may also be configured in ways that are not listed.

The terminology used herein is for describing particular embodiments only and is not intended to be limiting of the invention. As used herein, the singular forms “a,” “an,” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method, step of a method, device or element of a device that “comprises,” “has,” “includes,” or “contains,” or uses similar language to describe one or more steps or elements possesses those one or more steps or elements but is not limited to possessing only those one or more steps or elements.

The terms “couple,” “coupled,” “connected,” and the like should be broadly understood to refer to connecting two or more elements or signals electrically and/or mechanically, either directly or indirectly through intervening circuitry and/or elements. Two or more electrical elements may be electrically coupled, either direct or indirectly, but not be mechanically coupled; two or more mechanical elements may be mechanically coupled, either direct or indirectly, but not be electrically coupled; two or more electrical elements may be mechanically coupled, directly or indirectly, but not be electrically coupled. Coupling (whether only mechanical, only electrical, or both) may be for any length of time, e.g., permanent or semi-permanent or only for an instant. “Communicatively coupled to” and “operatively coupled to” can refer to physically and/or electrically related components.

In addition, as used herein, the terms “about,” “approximately,” or “substantially” for any numerical values or ranges indicate a suitable dimensional tolerance that allows the device, part, or collection of components to function for its intended purpose as described herein.

As used herein, the terms “enterprise” or “provider” generally describes a person or business enterprise (e.g., company, organization, institution, business, university, etc.) that hosts, maintains, or uses computer systems that provide functionality for the disclosed systems and methods. The term “enterprise” may generally describe a person or business enterprise providing goods and/or services. Interactions between an enterprise system and a user device can be implemented as an interaction between a computing system of the enterprise and a user device of a user. For instance, user(s) may provide various inputs that can be interpreted and analyzed using processing systems of the user device and/or processing systems of the enterprise system. Further, the enterprise computing system and the user device may be in communication via a network. According to various embodiments, the enterprise system and/or user device(s) may also be in communication with an external or third-party server of a third-party system that may be used to perform one or more server operations. In some embodiments, the functions of one illustrated system or server may be provided by multiple systems, servers, or computing devices, including those physically located at a central computer processing facility and/or those physically located at remote locations.

Embodiments of the present invention are described herein with reference to flowchart illustrations and/or block diagrams of computer-implemented method(s) and computing system(s). Each block or combinations of blocks of the flowchart illustrations and/or block diagrams can be implemented by computer readable program instructions or code that may be provided to a processor of a general-purpose computer, special purpose computer, programmable data processing apparatus or apparatuses (the term “apparatus” includes systems and computer program products), and/or other device(s). In particular, the computer readable program instructions, which can be executed via the processor of the computer, programmable data processing apparatus, and/or other device(s), create a means for implementing the functions/acts specified in the flowchart and/or block diagram block(s).

In one embodiment, computer readable program instructions may also be stored in one or more computer-readable storage media that can direct a computer, programmable data processing apparatus, and/or other device(s) to function in a particular manner such that a computer readable storage medium of the one or more computer-readable storage media having instructions stored therein comprises an article of manufacture that includes the computer readable program instructions, which implement aspects of the actions specified in the flowchart illustrations and/or block diagrams. In particular, the computer-readable program instructions may be used to produce a computer-implemented method by executing the instructions to implement the actions specified in the flowchart illustrations and/or block diagram block(s). Additionally or alternatively, these computer program instructions may be stored in a computer-readable memory that can direct a computer, programmable data processing apparatus, and/or other device(s) to function in a particular manner such that the instructions stored in the computer readable memory produce an article of manufacture that includes the computer readable program instructions, which implement the function/act specified in the flowchart and/or block diagram block(s). In some embodiments, computer-implemented steps/acts may be performed in combination with operator/human implemented steps/acts in order to carry out an embodiment of the invention.

In the flowchart illustrations and/or block diagrams disclosed herein, each block in the flowchart/diagrams may represent a module, segment, a specific instruction/function or portion of instructions/functions and incorporates one or more executable computer readable program instructions for implementing the specified logical function(s). Similarly, alternative implementations and processes may also incorporate various blocks of the flowcharts and block diagrams. For instance, in some implementations the functions noted in the blocks may occur out of the order noted in the figures. For example, two blocks shown in succession may be executed substantially concurrently, and/or the functions of the blocks may sometimes be executed in the reverse order, depending upon the functionality involved.

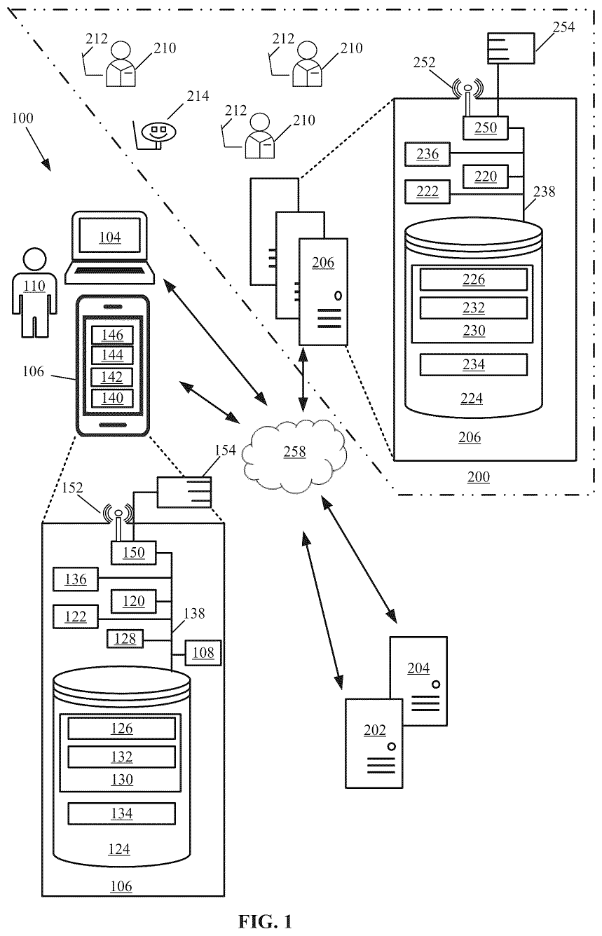

FIG. 1 illustrates a system 100 and environment thereof, according to at least one embodiment, by which a user 110 benefits through use of services and products of an enterprise system 200. The environment may include, for example, a distributed cloud computing environment (private cloud, public cloud, community cloud, and/or hybrid cloud), an on-premise environment, fog-computing environment, and/or an edge-computing environment. The user 110 accesses services and products by use of one or more user devices, illustrated in separate examples as a computing device 104 and a mobile device 106, which may be, as non-limiting examples, a smart phone, a portable digital assistant (PDA), a pager, a mobile television, a gaming device, a laptop computer, a camera, a video recorder, an audio/video player, radio, a global positioning service (GPS) device, or any combination of the aforementioned, or other portable device with processing and communication capabilities. In the illustrated example, the mobile device 106 is illustrated in FIG. 1 as having exemplary elements, the below descriptions of which apply as well to the computing device 104, which can be, as non-limiting examples, a desktop computer, a laptop computer, or other user-accessible computing device.

Furthermore, the user device, referring to either or both of the computing device 104 and the mobile device 106, may be or include a workstation, a server, or any other suitable device, including a set of servers, a cloud-based application or system, or any other suitable system, adapted to execute, for example any suitable operating system, including Linux, UNIX, Windows, macOS, iOS, Android and any other known operating system used on personal computers, central computing systems, phones, and other devices.

The user 110 can be an individual, a group, or any entity in possession of or having access to the user device, referring to either or both of the mobile device 104 and computing device 106, which may be personal or public items. Although the user 110 may be singly represented in some drawings, at least in some embodiments according to these descriptions the user 110 is one of many such that a market or community of users, consumers, customers, business entities, government entities, clubs, and groups of any size are all within the scope of these descriptions.

The user device, as illustrated with reference to the mobile device 106, includes components such as, at least one of each of a processing device 120, and a memory device 122 for processing use, such as random-access memory (RAM), and read-only memory (ROM). The illustrated mobile device 106 further includes a storage device 124 including at least one of a non-transitory storage medium, such as a microdrive, for long-term, intermediate-term, and short-term storage of computer-readable instructions 126 for execution by the processing device 120. For example, the instructions 126 can include instructions for an operating system and various applications or programs 130, of which the application 132 is represented as a particular example. The storage device 124 can store various other data items 134, which can include, as non-limiting examples, cached data, user files such as those for pictures, audio and/or video recordings, files downloaded or received from other devices, and other data items preferred by the user, required, or related to any or all of the applications or programs 130.

The memory device 122 is operatively coupled to the processing device 120. As used herein, memory includes any computer readable medium to store data, code, or other information. The memory device 122 may include volatile memory, such as volatile Random Access Memory (RAM) including a cache area for the temporary storage of data. The memory device 122 may also include non-volatile memory, which can be embedded and/or may be removable. The non-volatile memory can additionally or alternatively include an electrically erasable programmable read-only memory (EEPROM), flash memory or the like.

According to various embodiments, the memory device 122 and storage device 124 may be combined into a single storage medium. The memory device 122 and storage device 124 can store any of a number of applications which comprise computer-executable instructions and code executed by the processing device 120 to implement the functions of the mobile device 106 described herein. For example, the memory device 122 may include such applications as a conventional web browser application and/or a mobile P2P payment system client application. These applications also typically provide a graphical user interface (GUI) on the display 140 that allows the user 110 to communicate with the mobile device 106, and, for example a mobile banking system, and/or other devices or systems. In one embodiment, when the user 110 decides to enroll in a mobile banking program, the user 110 downloads or otherwise obtains the mobile banking system client application from a mobile banking system, for example enterprise system 200, or from a distinct application server. In other embodiments, the user 110 interacts with a mobile banking system via a web browser application in addition to, or instead of, the mobile P2P payment system client application.

The processing device 120, and other processors described herein, generally include circuitry for implementing communication and/or logic functions of the mobile device 106. For example, the processing device 120 may include a digital signal processor, a microprocessor, and various analog to digital converters, digital to analog converters, and/or other support circuits. Control and signal processing functions of the mobile device 106 are allocated between these devices according to their respective capabilities. The processing device 120 thus may also include the functionality to encode and interleave messages and data prior to modulation and transmission. The processing device 120 can additionally include an internal data modem. Further, the processing device 120 may include functionality to operate one or more software programs, which may be stored in the memory device 122, or in the storage device 124. For example, the processing device 120 may be capable of operating a connectivity program, such as a web browser application. The web browser application may then allow the mobile device 106 to transmit and receive web content, such as, for example, location-based content and/or other web page content, according to a Wireless Application Protocol (WAP), Hypertext Transfer Protocol (HTTP), and/or the like.

The memory device 122 and storage device 124 can each also store any of a number of pieces of information, and data, used by the user device and the applications and devices that facilitate functions of the user device, or are in communication with the user device, to implement the functions described herein and others not expressly described. For example, the storage device may include such data as user authentication information, etc.

The processing device 120, in various examples, can operatively perform calculations, can process instructions for execution, and can manipulate information. The processing device 120 can execute machine-executable instructions stored in the storage device 124 and/or memory device 122 to thereby perform methods and functions as described or implied herein, for example by one or more corresponding flow charts expressly provided or implied as would be understood by one of ordinary skill in the art to which the subject matters of these descriptions pertain. The processing device 120 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof. In some embodiments, particular portions or steps of methods and functions described herein are performed in whole or in part by way of the processing device 120, while in other embodiments methods and functions described herein include cloud-based computing in whole or in part such that the processing device 120 facilitates local operations including, as non-limiting examples, communication, data transfer, and user inputs and outputs such as receiving commands from and providing displays to the user.

The mobile device 106, as illustrated, includes an input and output system 136, referring to, including, or operatively coupled with, one or more user input devices and/or one or more user output devices, which are operatively coupled to the processing device 120. The input and output system 136 may include input/output circuitry that may operatively convert analog signals and other signals into digital data or may convert digital data to another type of signal. For example, the input/output circuitry may receive and convert physical contact inputs, physical movements, or auditory signals (e.g., which may be used to authenticate a user) to digital data. Once converted, the digital data may be provided to the processing device 120. The input and output system 136 may also include a display 140 (e.g., a liquid crystal display (LCD), light emitting diode (LED) display, or the like), which can be, as a non-limiting example, a presence-sensitive input screen (e.g., touch screen or the like) of the mobile device 106, which serves both as an output device, by providing graphical and text indicia and presentations for viewing by one or more user 110, and as an input device, by providing virtual buttons, selectable options, a virtual keyboard, and other indicia that, when touched, control the mobile device 106 by user action. The user output devices include a speaker 144 or other audio device. The user input devices, which allow the mobile device 106 to receive data and actions such as button manipulations and touches from a user such as the user 110, may include any of a number of devices allowing the mobile device 106 to receive data from a user, such as a keypad, keyboard, touch-screen, touchpad, microphone 142, mouse, joystick, other pointer device, button, soft key, infrared sensor, and/or other input device(s). Also, the input and output system 136 may include a camera 146, such as a digital camera.

Further non-limiting examples of input devices and/or output devices include, one or more of each, any, and all of a wireless or wired keyboard, a mouse, a touchpad, a button, a switch, a light, an LED, a buzzer, a bell, a printer and/or other user input devices and output devices for use by or communication with the user 110 in accessing, using, and controlling, in whole or in part, the user device, referring to either or both of the computing device 104 and a mobile device 106. Inputs by one or more user 110 can thus be made via voice, text or graphical indicia selections. For example, such inputs in some examples correspond to user-side actions and communications seeking services and products of the enterprise system 200, and at least some outputs in such examples correspond to data representing enterprise-side actions and communications in two-way communications between a user 110 and an enterprise system 200.

The input and output system 136 may also be configured to obtain and process various forms of authentication via an authentication system to obtain authentication information of a user 110. Various authentication systems may include, according to various embodiments, a recognition system that detects biometric features or attributes of a user such as, for example fingerprint recognition systems and the like (hand print recognition systems, palm print recognition systems, etc.), iris recognition and the like used to authenticate a user based on features of the user's eyes, facial recognition systems based on facial features of the user, DNA-based authentication, or any other suitable biometric attribute or information associated with a user. Additionally, or alternatively, voice biometric systems may be used to authenticate a user using speech recognition associated with a word, phrase, tone, or other voice-related features of the user. Alternate authentication systems may include one or more systems to identify a user based on a visual or temporal pattern of inputs provided by the user. For instance, the user device may display, for example, selectable options, shapes, inputs, buttons, numeric representations, etc. that must be selected in a pre-determined specified order or according to a specific pattern. Other authentication processes are also contemplated herein including, for example, email authentication, password protected authentication, device verification of saved devices, code-generated authentication, text message authentication, phone call authentication, etc. The user device may enable users to input any number or combination of authentication systems.

The user device, referring to either or both of the computing device 104 and the mobile device 106 may also include a positioning device 108, which can be for example a GPS configured to be used by a positioning system to determine a location of the computing device 104 or mobile device 106. For example, the positioning system device 108 may include a GPS transceiver. In some embodiments, the positioning system device 108 includes an antenna, transmitter, and receiver. For example, in one embodiment, triangulation of cellular signals may be used to identify the approximate location of the mobile device 106. In other embodiments, the positioning device 108 includes a proximity sensor or transmitter, such as an RFID tag, that can sense or be sensed by devices known to be located proximate a merchant or other location to determine that the mobile device 106 is located proximate these known devices.

In the illustrated example, a system intraconnect 138, connects, for example electrically, the various described, illustrated, and implied components of the mobile device 106. The intraconnect 138, in various non-limiting examples, can include or represent, a system bus, a high-speed interface connecting the processing device 120 to the memory device 122, individual electrical connections among the components, and electrical conductive traces on a motherboard common to some or all of the above-described components of the user device (referring to either or both of the computing device 104 and the mobile device 106). As discussed herein, the system intraconnect 138 may operatively couple various components with one another, or in other words, electrically connects those components, either directly or indirectly—by way of intermediate component(s)—with one another.

The user device, referring to either or both of the computing device 104 and the mobile device 106, with particular reference to the mobile device 106 for illustration purposes, includes a communication interface 150, by which the mobile device 106 communicates and conducts transactions with other devices and systems. The communication interface 150 may include digital signal processing circuitry and may provide two-way communications and data exchanges, for example wirelessly via wireless communication device 152, and for an additional or alternative example, via wired or docked communication by mechanical electrically conductive connector 154. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless communication device 152, which can be or include a radio-frequency transceiver, a Bluetooth device, Wi-Fi device, a Near-field communication device, and other transceivers. In addition, GPS (Global Positioning System) may be included for navigation and location-related data exchanges, ingoing and/or outgoing. Communications may also or alternatively be conducted via the connector 154 for wired connections such by USB, Ethernet, and other physically connected modes of data transfer.

The processing device 120 is configured to use the communication interface 150 as, for example, a network interface to communicate with one or more other devices on a network. In this regard, the communication interface 150 utilizes the wireless communication device 152 as an antenna operatively coupled to a transmitter and a receiver (together a “transceiver”) included with the communication interface 150. The processing device 120 is configured to provide signals to and receive signals from the transmitter and receiver, respectively. The signals may include signaling information in accordance with the air interface standard of the applicable cellular system of a wireless telephone network. In this regard, the mobile device 106 may be configured to operate with one or more air interface standards, communication protocols, modulation types, and access types. By way of illustration, the mobile device 106 may be configured to operate in accordance with any of a number of first, second, third, fourth, fifth-generation communication protocols and/or the like. For example, the mobile device 106 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols such as Long-Term Evolution (LTE), fifth-generation (5G) wireless communication protocols, Bluetooth Low Energy (BLE) communication protocols such as Bluetooth 5.0, ultra-wideband (UWB) communication protocols, and/or the like. The mobile device 106 may also be configured to operate in accordance with non-cellular communication mechanisms, such as via a wireless local area network (WLAN) or other communication/data networks.

The communication interface 150 may also include a payment network interface. The payment network interface may include software, such as encryption software, and hardware, such as a modem, for communicating information to and/or from one or more devices on a network. For example, the mobile device 106 may be configured so that it can be used as a credit or debit card by, for example, wirelessly communicating account numbers or other authentication information to a terminal of the network. Such communication could be performed via transmission over a wireless communication protocol such as the Near-field communication protocol.

The mobile device 106 further includes a power source 128, such as a battery, for powering various circuits and other devices that are used to operate the mobile device 106. Embodiments of the mobile device 106 may also include a clock or other timer configured to determine and, in some cases, communicate actual or relative time to the processing device 120 or one or more other devices. For further example, the clock may facilitate timestamping transmissions, receptions, and other data for security, authentication, logging, polling, data expiry, and forensic purposes.

System 100 as illustrated diagrammatically represents at least one example of a possible implementation, where alternatives, additions, and modifications are possible for performing some or all of the described methods, operations and functions. Although shown separately, in some embodiments, two or more systems, servers, or illustrated components may utilized. In some implementations, the functions of one or more systems, servers, or illustrated components may be provided by a single system or server. In some embodiments, the functions of one illustrated system or server may be provided by multiple systems, servers, or computing devices, including those physically located at a central facility, those logically local, and those located as remote with respect to each other.

The enterprise system 200 can offer any number or type of services and products to one or more users 110. In some examples, an enterprise system 200 offers products. In some examples, an enterprise system 200 offers services. Use of “service(s)” or “product(s)” thus relates to either or both in these descriptions. With regard, for example, to online information and financial services, “service” and “product” are sometimes termed interchangeably. In non-limiting examples, services and products include retail services and products, information services and products, custom services and products, predefined or pre-offered services and products, consulting services and products, advising services and products, forecasting services and products, internet products and services, social media, and financial services and products, which may include, in non-limiting examples, services and products relating to banking, checking, savings, investments, credit cards, automatic-teller machines, debit cards, loans, mortgages, personal accounts, business accounts, account management, credit reporting, credit requests, and credit scores.

To provide access to, or information regarding, some or all the services and products of the enterprise system 200, automated assistance may be provided by the enterprise system 200. For example, automated access to user accounts and replies to inquiries may be provided by enterprise-side automated voice, text, and graphical display communications and interactions. In at least some examples, any number of human agents 210 can be employed, utilized, authorized or referred by the enterprise system 200. Such human agents 210 can be, as non-limiting examples, point of sale or point of service (POS) representatives, online customer service assistants available to users 110, advisors, managers, sales team members, and referral agents ready to route user requests and communications to preferred or particular other agents, human or virtual.

Human agents 210 may utilize agent devices 212 to serve users in their interactions to communicate and take action. The agent devices 212 can be, as non-limiting examples, computing devices, kiosks, terminals, smart devices such as phones, and devices and tools at customer service counters and windows at POS locations. In at least one example, the diagrammatic representation of the components of the user device 106 in FIG. 1 applies as well to one or both of the computing device 104 and the agent devices 212.

Agent devices 212 individually or collectively include input devices and output devices, including, as non-limiting examples, a touch screen, which serves both as an output device by providing graphical and text indicia and presentations for viewing by one or more agent 210, and as an input device by providing virtual buttons, selectable options, a virtual keyboard, and other indicia that, when touched or activated, control or prompt the agent device 212 by action of the attendant agent 210. Further non-limiting examples include, one or more of each, any, and all of a keyboard, a mouse, a touchpad, a joystick, a button, a switch, a light, an LED, a microphone serving as input device for example for voice input by a human agent 210, a speaker serving as an output device, a camera serving as an input device, a buzzer, a bell, a printer and/or other user input devices and output devices for use by or communication with a human agent 210 in accessing, using, and controlling, in whole or in part, the agent device 212.

Inputs by one or more human agents 210 can thus be made via voice, text or graphical indicia selections. For example, some inputs received by an agent device 212 in some examples correspond to, control, or prompt enterprise-side actions and communications offering services and products of the enterprise system 200, information thereof, or access thereto. At least some outputs by an agent device 212 in some examples correspond to, or are prompted by, user-side actions and communications in two-way communications between a user 110 and an enterprise-side human agent 210.

From a user perspective experience, an interaction in some examples within the scope of these descriptions begins with direct or first access to one or more human agents 210 in person, by phone, or online for example via a chat session or website function or feature. In other examples, a user is first assisted by a virtual agent 214 of the enterprise system 200, which may satisfy user requests or prompts by voice, text, or online functions, and may refer users to one or more human agents 210 once preliminary determinations or conditions are made or met.

A computing system 206 of the enterprise system 200 may include components such as, at least one of each of a processing device 220, and a memory device 222 for processing use, such as random-access memory (RAM), and read-only memory (ROM). The illustrated computing system 206 further includes a storage device 224 including at least one non-transitory storage medium, such as a microdrive, for long-term, intermediate-term, and short-term storage of computer-readable instructions 226 for execution by the processing device 220. For example, the instructions 226 can include instructions for an operating system and various applications or programs 230, of which the application 232 is represented as a particular example. The storage device 224 can store various other data 234, which can include, as non-limiting examples, cached data, and files such as those for user accounts, user profiles, account balances, and transaction histories, files downloaded or received from other devices, and other data items preferred by the user or required or related to any or all of the applications or programs 230.

The computing system 206, in the illustrated example, includes an input/output system 236, referring to, including, or operatively coupled with input devices and output devices such as, in a non-limiting example, agent devices 212, which have both input and output capabilities.

In the illustrated example, a system intraconnect 238 electrically connects the various above-described components of the computing system 206. In some cases, the intraconnect 238 operatively couples components to one another, which indicates that the components may be directly or indirectly connected, such as by way of one or more intermediate components. The intraconnect 238, in various non-limiting examples, can include or represent, a system bus, a high-speed interface connecting the processing device 220 to the memory device 222, individual electrical connections among the components, and electrical conductive traces on a motherboard common to some or all of the above-described components of the user device.

The computing system 206, in the illustrated example, includes a communication interface 250, by which the computing system 206 communicates and conducts transactions with other devices and systems. The communication interface 250 may include digital signal processing circuitry and may provide two-way communications and data exchanges, for example wirelessly via wireless device 252, and for an additional or alternative example, via wired or docked communication by mechanical electrically conductive connector 254. Communications may be conducted via various modes or protocols, of which GSM voice calls, SMS, EMS, MMS messaging, TDMA, CDMA, PDC, WCDMA, CDMA2000, and GPRS, are all non-limiting and non-exclusive examples. Thus, communications can be conducted, for example, via the wireless device 252, which can be or include a radio-frequency transceiver, a Bluetooth device, Wi-Fi device, Near-field communication device, and other transceivers. In addition, GPS (Global Positioning System) may be included for navigation and location-related data exchanges, ingoing and/or outgoing. Communications may also or alternatively be conducted via the connector 254 for wired connections such as by USB, Ethernet, and other physically connected modes of data transfer.

The processing device 220, in various examples, can operatively perform calculations, can process instructions for execution, and can manipulate information. The processing device 220 can execute machine-executable instructions stored in the storage device 224 and/or memory device 222 to thereby perform methods and functions as described or implied herein, for example by one or more corresponding flow charts expressly provided or implied as would be understood by one of ordinary skill in the art to which the subjects matter of these descriptions pertain. The processing device 220 can be or can include, as non-limiting examples, a central processing unit (CPU), a microprocessor, a graphics processing unit (GPU), a microcontroller, an application-specific integrated circuit (ASIC), a programmable logic device (PLD), a digital signal processor (DSP), a field programmable gate array (FPGA), a state machine, a controller, gated or transistor logic, discrete physical hardware components, and combinations thereof.

Furthermore, the computing device 206, may be or include a workstation, a server, or any other suitable device, including a set of servers, a cloud-based application or system, or any other suitable system, adapted to execute, for example any suitable operating system, including Linux, UNIX, Windows, macOS, iOS, Android, and any known other operating system used on personal computer, central computing systems, phones, and other devices.

The user devices, referring to either or both of the computing device 104 and mobile device 106, the agent devices 212, and the enterprise computing system 206, which may be one or any number centrally located or distributed, are in communication through one or more networks, referenced as network 258 in FIG. 1.

Network 258 provides wireless or wired communications among the components of the system 100 and the environment thereof, including other devices local or remote to those illustrated, such as additional mobile devices, servers, and other devices communicatively coupled to network 258, including those not illustrated in FIG. 1. The network 258 is singly depicted for illustrative convenience but may include more than one network without departing from the scope of these descriptions. In some embodiments, the network 258 may be or provide one or more cloud-based services or operations. The network 258 may be or include an enterprise or secured network, or may be implemented, at least in part, through one or more connections to the Internet. A portion of the network 258 may be a virtual private network (VPN) or an Intranet. The network 258 can include wired and wireless links, including, as non-limiting examples, 802.11a/b/g/n/ac, 802.20, WiMax, LTE, and/or any other wireless link. The network 258 may include any internal or external network, networks, sub-network, and combinations of such operable to implement communications between various computing components within and beyond the illustrated environment 100. The network 258 may communicate, for example, Internet Protocol (IP) packets, Frame Relay frames, Asynchronous Transfer Mode (ATM) cells, voice, video, data, and other suitable information between network addresses. The network 258 may also include one or more local area networks (LANs), radio access networks (RANs), metropolitan area networks (MANs), wide area networks (WANs), all or a portion of the internet and/or any other communication system or systems at one or more locations.

The network 258 may incorporate a cloud platform/data center that support various service models including Platform as a Service (PaaS), Infrastructure-as-a-Service (IaaS), and Software-as-a-Service (SaaS). Such service models may provide, for example, a digital platform accessible to the user device (referring to either or both of the computing device 104 and the mobile device 106). Specifically, SaaS may provide a user with the capability to use applications running on a cloud infrastructure, where the applications are accessible via a thin client interface such as a web browser and the user is not permitted to manage or control the underlying cloud infrastructure (i.e., network, servers, operating systems, storage, or specific application capabilities that are not user-specific). PaaS also do not permit the user to manage or control the underlying cloud infrastructure, but this service may enable a user to deploy user-created or acquired applications onto the cloud infrastructure using programming languages and tools provided by the provider of the application. In contrast, IaaS provides a user the permission to provision processing, storage, networks, and other computing resources as well as run arbitrary software (e.g., operating systems and applications) thereby giving the user control over operating systems, storage, deployed applications, and potentially select networking components (e.g., host firewalls).

The network 258 may also incorporate various cloud-based deployment models including private cloud (i.e., an organization-based cloud managed by either the organization or third parties and hosted on-premises or off premises), public cloud (i.e., cloud-based infrastructure available to the general public that is owned by an organization that sells cloud services), community cloud (i.e., cloud-based infrastructure shared by several organizations and manages by the organizations or third parties and hosted on-premises or off premises), and/or hybrid cloud (i.e., composed of two or more clouds e.g., private community, and/or public).

Two external systems 202 and 204 are expressly illustrated in FIG. 1, representing any number and variety of data sources, user devices, business entity devices, banking system devices, government entity devices, third-party PaaS, third-party IaaS, and external databases, are all within the scope of the descriptions. In at least one example, the external systems 202 and 204 represent automatic teller machines (ATMs) utilized by the enterprise system 200 in serving users 110. In another example, the external systems 202 and 204 represent payment clearinghouse or payment rail systems for processing payment transactions, and in another example, the external systems 202 and 204 represent third party systems such as merchant systems configured to interact with the user device 106 during transactions and also configured to interact with the enterprise system 200 in back-end transactions clearing processes. According to various embodiments, external systems 202 and 204 may utilize software applications that function using external resources that are available through a third-party provider such as SaaS, PaaS, or IaaS service models. Such external systems 202, 204 include the third-party systems accessible via the agent devices 212 using a software application (e.g., an integrated mobile software application or an application programming interface (API) software application) that can be integrated with the computing system 206 to facilitate communication between software and systems and also configured to utilize different data formats between systems. In another embodiment, the third-party system may be accessible by the agent devices 212 using a web-based software interface (e.g., a website).

In certain embodiments, one or more of the systems such as the user device (referring to either or both of the computing device 104 and the mobile device 106), the enterprise system 200, and/or the external systems 202 and 204 are, include, or utilize virtual resources. In some cases, such virtual resources are considered cloud resources or virtual machines. The cloud computing configuration may provide an infrastructure that includes a network of interconnected nodes and provides stateless, low coupling, modularity, and semantic interoperability. Such interconnected nodes may incorporate a computer system that includes one or more processors, a memory, and a bus that couples various system components (e.g., the memory) to the processor. Such virtual resources may be available for shared use among multiple distinct resource consumers and in certain implementations, virtual resources do not necessarily correspond to one or more specific pieces of hardware, but rather to a collection of pieces of hardware operatively coupled within a cloud computing configuration so that the resources may be shared as needed.

As used herein, an artificial intelligence system, artificial intelligence algorithm, artificial intelligence module, program, and the like, generally refer to computer implemented programs that are suitable to simulate intelligent behavior (i.e., intelligent human behavior) and/or computer systems and associated programs suitable to perform tasks that typically require a human to perform, such as tasks requiring visual perception, speech recognition, decision-making, translation, and the like. An artificial intelligence system may include, for example, at least one of a series of associated if-then logic statements, a statistical model suitable to map raw sensory data into symbolic categories and the like, or a machine learning program. A machine learning program, machine learning algorithm, or machine learning module, as used herein, is generally a type of artificial intelligence including one or more algorithms that can learn and/or adjust parameters based on input data provided to the algorithm. In some instances, machine learning programs, algorithms, and modules are used at least in part in implementing artificial intelligence (AI) functions, systems, and methods.

Artificial Intelligence (AI) and/or machine learning programs may be associated with or conducted by one or more processors, memory devices, and/or storage devices of a computing system or device. It should be appreciated that the AI algorithm or program may be incorporated within the existing system architecture or be configured as a standalone modular component, controller, or the like communicatively coupled to the system. An AI program and/or machine learning program may generally be configured to perform methods and functions as described or implied herein, for example by one or more corresponding flow charts expressly provided or implied as would be understood by one of ordinary skill in the art to which the subjects matter of these descriptions pertain.

A machine learning program may be configured to use various analytical tools (e.g., algorithmic applications) to leverage data to make predictions or decisions. Machine learning programs may be configured to implement various algorithmic processes and learning approaches including, for example, decision tree learning, association rule learning, artificial neural networks, recurrent artificial neural networks, long short term memory networks, inductive logic programming, support vector machines, clustering, Bayesian networks, reinforcement learning, representation learning, similarity and metric learning, sparse dictionary learning, genetic algorithms, k-nearest neighbor (KNN), and the like. In some embodiments, the machine learning algorithm may include one or more image recognition algorithms suitable to determine one or more categories to which an input, such as data communicated from a visual sensor or a file in JPEG, PNG or other format, representing an image or portion thereof, belongs. Additionally, or alternatively, the machine learning algorithm may include one or more regression algorithms configured to output a numerical value given an input. Further, the machine learning may include one or more pattern recognition algorithms, e.g., a module, subroutine or the like capable of translating text or string characters and/or a speech recognition module or subroutine. In various embodiments, the machine learning module may include a machine learning acceleration logic, e.g., a fixed function matrix multiplication logic, in order to implement the stored processes and/or optimize the machine learning logic training and interface.

Machine learning models are trained using various data inputs and techniques. Example training methods may include, for example, supervised learning, (e.g., decision tree learning, support vector machines, similarity and metric learning, etc.), unsupervised learning, (e.g., association rule learning, clustering, etc.), reinforcement learning, semi-supervised learning, self-supervised learning, multi-instance learning, inductive learning, deductive inference, transductive learning, sparse dictionary learning and the like. Example clustering algorithms used in unsupervised learning may include, for example, k-means clustering, density based special clustering of applications with noise (DBSCAN), mean shift clustering, expectation maximization (EM) clustering using Gaussian mixture models (GMM), agglomerative hierarchical clustering, or the like. According to one embodiment, clustering of data may be performed using a cluster model to group data points based on certain similarities using unlabeled data. Example cluster models may include, for example, connectivity models, centroid models, distribution models, density models, group models, graph-based models, neural models and the like.

One subfield of machine learning includes neural networks, which take inspiration from biological neural networks. In machine learning, a neural network includes interconnected units that process information by responding to external inputs to find connections and derive meaning from undefined data. A neural network can, in a sense, learn to perform tasks by interpreting numerical patterns that take the shape of vectors and by categorizing data based on similarities, without being programmed with any task-specific rules. A neural network generally includes connected units, neurons, or nodes (e.g., connected by synapses) and may allow for the machine learning program to improve performance. A neural network may define a network of functions, which have a graphical relationship. Various neural networks that implement machine learning exist including, for example, feedforward artificial neural networks, perceptron and multilayer perceptron neural networks, radial basis function artificial neural networks, recurrent artificial neural networks, modular neural networks, long short-term memory networks, as well as various other neural networks.

Neural networks may perform a supervised learning process where known inputs and known outputs are utilized to categorize, classify, or predict a quality of a future input. However, additional or alternative embodiments of the machine learning program may be trained utilizing unsupervised or semi-supervised training, where none of the outputs or some of the outputs are unknown, respectively. Typically, a machine learning algorithm is trained (e.g., utilizing a training data set) prior to modeling the problem with which the algorithm is associated. Supervised training of the neural network may include choosing a network topology suitable for the problem being modeled by the network and providing a set of training data representative of the problem. Generally, the machine learning algorithm may adjust the weight coefficients until any error in the output data generated by the algorithm is less than a predetermined, acceptable level. For instance, the training process may include comparing the generated output produced by the network, in response to the training data, with a desired or correct output. An associated error amount may then be determined for the generated output data, such as for each output data point generated in the output layer. The associated error amount may be communicated back through the system as an error signal, where the weight coefficients assigned in the hidden layer are adjusted based on the error signal. For instance, the associated error amount (e.g., a value between-1 and 1) may be used to modify the previous coefficient, e.g., a propagated value. The machine learning algorithm may be considered sufficiently trained when the associated error amount for the output data is less than the predetermined, acceptable level (e.g., each data point within the output layer includes an error amount less than the predetermined, acceptable level). Thus, the parameters determined from the training process can be utilized with new input data to categorize, classify, and/or predict other values based on the new input data.

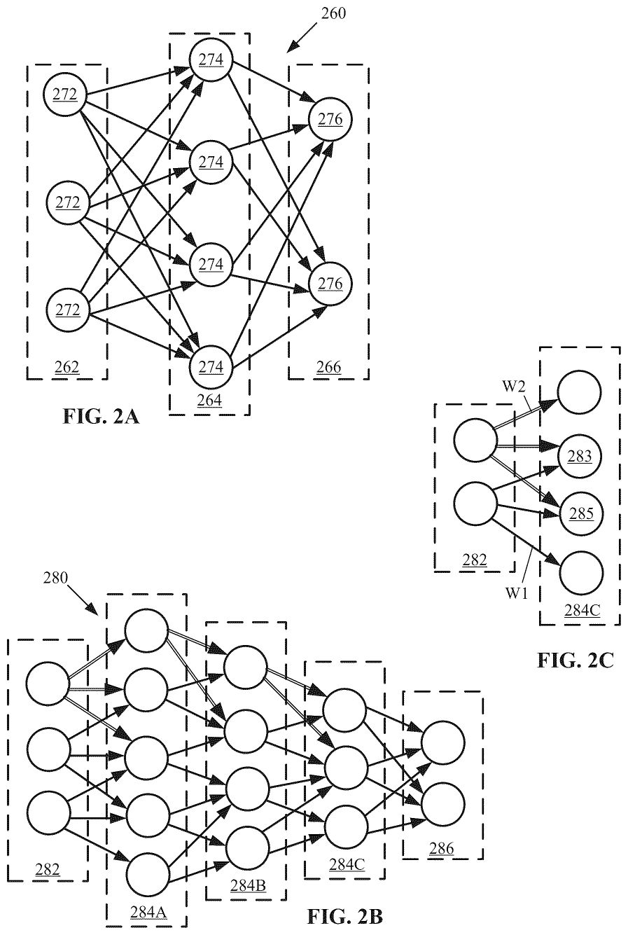

An artificial neural network (ANN), also known as a feedforward network, may be utilized, e.g., an acyclic graph with nodes arranged in layers. A feedforward network (see, e.g., feedforward network 260 referenced in FIG. 2A) may include a topography with a hidden layer 264 between an input layer 262 and an output layer 266. The input layer 262, having nodes commonly referenced in FIG. 2A as input nodes 272 for convenience, communicates input data, variables, matrices, or the like to the hidden layer 264, having nodes 274. The hidden layer 264 generates a representation and/or transformation of the input data into a form that is suitable for generating output data. Adjacent layers of the topography are connected at the edges of the nodes of the respective layers, but nodes within a layer typically are not separated by an edge. In at least one embodiment of such a feedforward network, data is communicated to the nodes 272 of the input layer, which then communicates the data to the hidden layer 264. The hidden layer 264 may be configured to determine the state of the nodes in the respective layers and assign weight coefficients or parameters of the nodes based on the edges separating each of the layers, e.g., an activation function implemented between the input data communicated from the input layer 262 and the output data communicated to the nodes 276 of the output layer 266. It should be appreciated that the form of the output from the neural network may generally depend on the type of model represented by the algorithm. Although the feedforward network 260 of FIG. 2A expressly includes a single hidden layer 264, other embodiments of feedforward networks within the scope of the descriptions can include any number of hidden layers. The hidden layers are intermediate the input and output layers and are generally where all or most of the computation is done.

An additional or alternative type of neural network suitable for use in the machine learning program and/or module is a Convolutional Neural Network (CNN). A CNN is a type of feedforward neural network that may be utilized to model data associated with input data having a grid-like topology. In some embodiments, at least one layer of a CNN may include a sparsely connected layer, in which each output of a first hidden layer does not interact with each input of the next hidden layer. For example, the output of the convolution in the first hidden layer may be an input of the next hidden layer, rather than a respective state of each node of the first layer. CNNs are typically trained for pattern recognition, such as speech processing, language processing, and visual processing. As such, CNNs may be particularly useful for implementing optical and pattern recognition programs required from the machine learning program. A CNN includes an input layer, a hidden layer, and an output layer, typical of feedforward networks, but the nodes of a CNN input layer are generally organized into a set of categories via feature detectors and based on the receptive fields of the sensor, retina, input layer, etc. Each filter may then output data from its respective nodes to corresponding nodes of a subsequent layer of the network. A CNN may be configured to apply the convolution mathematical operation to the respective nodes of each filter and communicate the same to the corresponding node of the next subsequent layer. As an example, the input to the convolution layer may be a multidimensional array of data. The convolution layer, or hidden layer, may be a multidimensional array of parameters determined while training the model.

An exemplary convolutional neural network CNN is depicted and referenced as 280 in FIG. 2B. As in the basic feedforward network 260 of FIG. 2A, the illustrated example of FIG. 2B has an input layer 282 and an output layer 286. However, where a single hidden layer 264 is represented in FIG. 2A, multiple consecutive hidden layers 284A, 284B, and 284C are represented in FIG. 2B. The edge neurons represented by white-filled arrows highlight that hidden layer nodes can be connected locally, such that not all nodes of succeeding layers are connected by neurons. FIG. 2C, representing a portion of the convolutional neural network 280 of FIG. 2B, specifically portions of the input layer 282 and the first hidden layer 284A, illustrates that connections can be weighted. In the illustrated example, labels W1 and W2 refer to respective assigned weights for the referenced connections. Two hidden nodes 283 and 285 share the same set of weights W1 and W2 when connecting to two local patches.

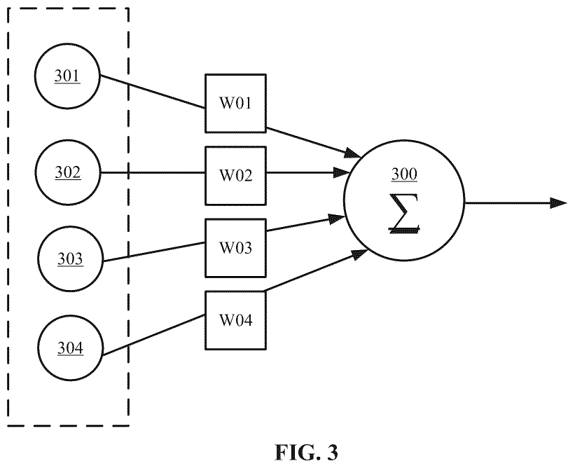

Weight defines the impact a node in any given layer has on computations by a connected node in the next layer. FIG. 3 represents a particular node 300 in a hidden layer. The node 300 is connected to several nodes in the previous layer representing inputs to the node 300. The input nodes 301, 302, 303 and 304 are each assigned a respective weight W01, W02, W03, and W04 in the computation at the node 300, which in this example is a weighted sum.

An additional or alternative type of feedforward neural network suitable for use in the machine learning program and/or module is a Recurrent Neural Network (RNN). An RNN may allow for analysis of sequences of inputs rather than only considering the current input data set. RNNs typically include feedback loops/connections between layers of the topography, thus allowing parameter data to be communicated between different parts of the neural network. RNNs typically have an architecture including cycles, where past values of a parameter influence the current calculation of the parameter, e.g., at least a portion of the output data from the RNN may be used as feedback/input in calculating subsequent output data. In some embodiments, the machine learning module may include an RNN configured for language processing, e.g., an RNN configured to perform statistical language modeling to predict the next word in a string based on the previous words. The RNN(s) of the machine learning program may include a feedback system suitable to provide the connection(s) between subsequent and previous layers of the network.

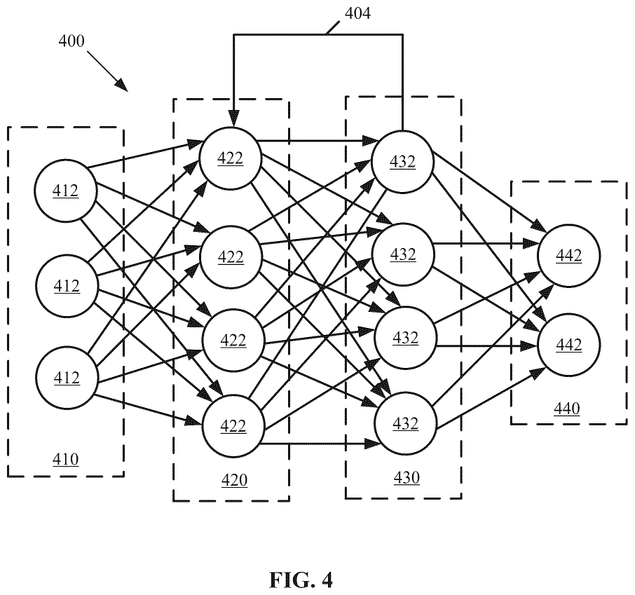

An example for a Recurrent Neural Network RNN is referenced as 400 in FIG. 4. As in the basic feedforward network 260 of FIG. 2A, the illustrated example of FIG. 4 has an input layer 410 (with nodes 412) and an output layer 440 (with nodes 442). However, where a single hidden layer 264 is represented in FIG. 2A, multiple consecutive hidden layers 420 and 430 are represented in FIG. 4 (with nodes 422 and nodes 432, respectively). As shown, the RNN 400 includes a feedback connector 404 configured to communicate parameter data from at least one node 432 from the second hidden layer 430 to at least one node 422 of the first hidden layer 420. It should be appreciated that two or more and up to all of the nodes of a subsequent layer may provide or communicate a parameter or other data to a previous layer of the RNN 400. Moreover, and in some embodiments, the RNN 400 may include multiple feedback connectors 404 (e.g., connectors 404 suitable to communicatively couple pairs of nodes and/or connector systems 404 configured to provide communication between three or more nodes). Additionally, or alternatively, the feedback connector 404 may communicatively couple two or more nodes having at least one hidden layer between them, i.e., nodes of non-sequential layers of the RNN 400.

In an additional or alternative embodiment, the machine-learning program may include one or more support vector machines. A support vector machine may be configured to determine a category to which input data belongs. For example, the machine-learning program may be configured to define a margin using a combination of two or more of the input variables and/or data points as support vectors to maximize the determined margin. Such a margin may generally correspond to a distance between the closest vectors that are classified differently. The machine-learning program may be configured to utilize a plurality of support vector machines to perform a single classification. For example, the machine-learning program may determine the category to which input data belongs using a first support vector determined from first and second data points/variables, and the machine-learning program may independently categorize the input data using a second support vector determined from third and fourth data points/variables. The support vector machine(s) may be trained similarly to the training of neural networks, e.g., by providing a known input vector (including values for the input variables) and a known output classification. The support vector machine is trained by selecting the support vectors and/or a portion of the input vectors that maximize the determined margin.

As depicted, and in some embodiments, the machine-learning program may include a neural network topography having more than one hidden layer. In such embodiments, one or more of the hidden layers may have a different number of nodes and/or the connections defined between layers. In some embodiments, each hidden layer may be configured to perform a different function. As an example, a first layer of the neural network may be configured to reduce a dimensionality of the input data, and a second layer of the neural network may be configured to perform statistical programs on the data communicated from the first layer. In various embodiments, each node of the previous layer of the network may be connected to an associated node of the subsequent layer (dense layers). Generally, the neural network(s) of the machine-learning program may include a relatively large number of layers, e.g., three or more layers, and may be referred to as deep neural networks. For example, the node of each hidden layer of a neural network may be associated with an activation function utilized by the machine-learning program to generate an output received by a corresponding node in the subsequent layer. The last hidden layer of the neural network communicates a data set (e.g., the result of data processed within the respective layer) to the output layer. Deep neural networks may require more computational time and power to train, but the additional hidden layers provide multistep pattern recognition capability and/or reduced output error relative to simple or shallow machine learning architectures (e.g., including only one or two hidden layers).

According to various implementations, deep neural networks incorporate neurons, synapses, weights, biases, and functions and can be trained to model complex non-linear relationships. Various deep learning frameworks may include, for example, TensorFlow, MxNet, PyTorch, Keras, Gluon, and the like. Training a deep neural network may include complex input/output transformations and may include, according to various embodiments, a backpropagation algorithm. According to various embodiments, deep neural networks may be configured to classify images of handwritten digits from a dataset or various other images. According to various embodiments, the datasets may include a collection of files that are unstructured and lack predefined data model schema or organization. Unlike structured data, which is usually stored in a relational database (RDBMS) and can be mapped into designated fields, unstructured data comes in many formats that can be challenging to process and analyze. Examples of unstructured data may include, according to non-limiting examples, dates, numbers, facts, emails, text files, scientific data, satellite imagery, media files, social media data, text messages, mobile communication data, and the like.

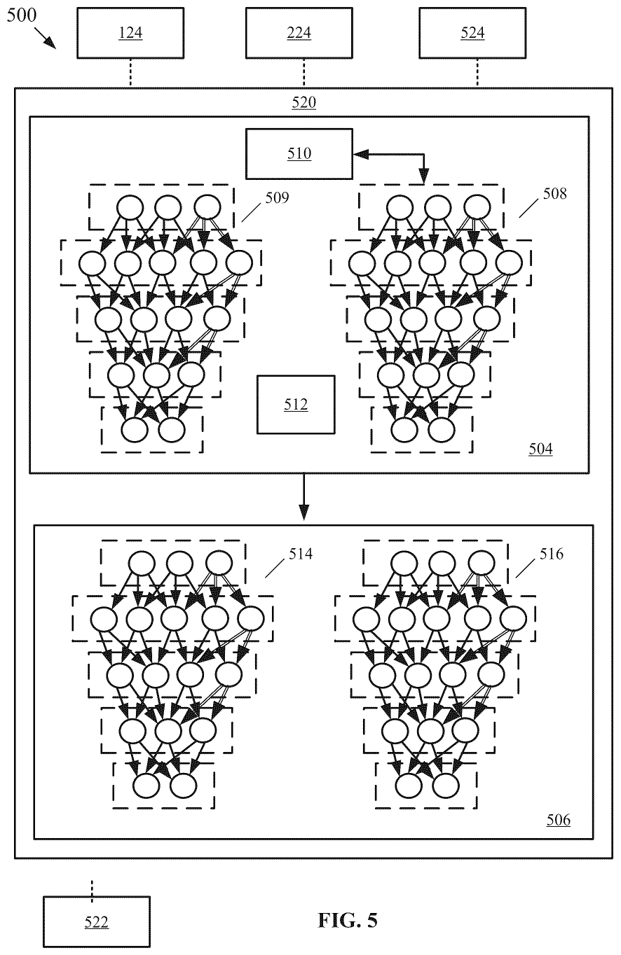

Referring now to FIG. 5 and some embodiments, an AI program 502 may include a front-end algorithm 504 and a back-end algorithm 506. The artificial intelligence program 502 may be implemented on an AI processor 520, such as the processing device 120, the processing device 220, and/or a dedicated processing device. The instructions associated with the front-end algorithm 504 and the back-end algorithm 506 may be stored in an associated memory device and/or storage device of the system (e.g., storage device 124, memory device 122, storage device 224, and/or memory device 222) communicatively coupled to the AI processor 520, as shown. Additionally, or alternatively, the system may include one or more memory devices and/or storage devices (represented by memory 524 in FIG. 5) for processing use and/or including one or more instructions necessary for operation of the AI program 502. In some embodiments, the AI program 502 may include a deep neural network (e.g., a front-end network 504 configured to perform pre-processing, such as feature recognition, and a back-end network 506 configured to perform an operation on the data set communicated directly or indirectly to the back-end network 506). For instance, the front-end program 506 can include at least one CNN 508 communicatively coupled to send output data to the back-end network 506.

Additionally, or alternatively, the front-end program 504 can include one or more AI algorithms 510, 512 (e.g., statistical models or machine learning programs such as decision tree learning, associate rule learning, recurrent artificial neural networks, support vector machines, and the like). In various embodiments, the front-end program 504 may be configured to include built in training and inference logic or suitable software to train the neural network prior to use (e.g., machine learning logic including, but not limited to, image recognition, mapping and localization, autonomous navigation, speech synthesis, document imaging, or language translation such as natural language processing). For example, a CNN 508 and/or AI algorithm 510 may be used for image recognition, input categorization, and/or support vector training. In some embodiments and within the front-end program 504, an output from an AI algorithm 510 may be communicated to a CNN 508 or 509, which processes the data before communicating an output from the CNN 508, 509 and/or the front-end program 504 to the back-end program 506. In various embodiments, the back-end network 506 may be configured to implement input and/or model classification, speech recognition, translation, and the like. For instance, the back-end network 506 may include one or more CNNs (e.g., CNN 514) or dense networks (e.g., dense networks 516), as described herein.

For instance, and in some embodiments of the AI program 502, the program may be configured to perform unsupervised learning, in which the machine learning program performs the training process using unlabeled data, e.g., without known output data with which to compare. During such unsupervised learning, the neural network may be configured to generate groupings of the input data and/or determine how individual input data points are related to the complete input data set (e.g., via the front-end program 504). For example, unsupervised training may be used to configure a neural network to generate a self-organizing map, reduce the dimensionally of the input data set, and/or to perform outlier/anomaly determinations to identify data points in the data set that falls outside the normal pattern of the data. In some embodiments, the AI program 502 may be trained using a semi-supervised learning process in which some but not all of the output data is known, e.g., a mix of labeled and unlabeled data having the same distribution.

In some embodiments, the AI program 502 may be accelerated via a machine-learning framework 522 (e.g., hardware). The machine learning framework may include an index of basic operations, subroutines, and the like (primitives) typically implemented by AI and/or machine learning algorithms. Thus, the AI program 502 may be configured to utilize the primitives of the framework 522 to perform some or all of the calculations required by the AI program 502. Primitives suitable for inclusion in the machine learning framework 522 include operations associated with training a convolutional neural network (e.g., pools), tensor convolutions, activation functions, basic algebraic subroutines and programs (e.g., matrix operations, vector operations), numerical method subroutines and programs, and the like.

It should be appreciated that the machine-learning program may include variations, adaptations, and alternatives suitable to perform the operations necessary for the system, and the present disclosure is equally applicable to such suitably configured machine learning and/or artificial intelligence programs, modules, etc. For instance, the machine-learning program may include one or more long short-term memory (LSTM) RNNs, convolutional deep belief networks, deep belief networks DBNs, and the like. DBNs, for instance, may be utilized to pre-train the weighted characteristics and/or parameters using an unsupervised learning process. Further, the machine-learning module may include one or more other machine learning tools (e.g., Logistic Regression (LR), Naive-Bayes, Random Forest (RF), matrix factorization, and support vector machines) in addition to, or as an alternative to, one or more neural networks, as described herein.

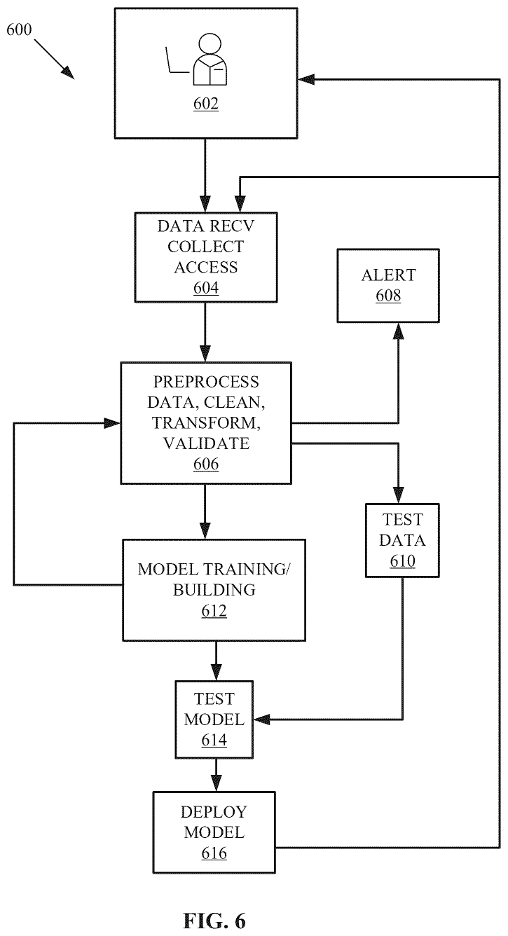

FIG. 6 is a flow chart representing a method 600, according to at least one embodiment, of model development and deployment by machine learning. The method 600 represents at least one example of a machine learning workflow in which steps are implemented in a machine-learning project.

In step 602, a user authorizes, requests, manages, or initiates the machine-learning workflow. This may represent a user such as human agent, or customer, requesting machine-learning assistance or AI functionality to simulate intelligent behavior (such as a virtual agent) or other machine-assisted or computerized tasks that may, for example, entail visual perception, speech recognition, decision-making, translation, forecasting, predictive modelling, and/or suggestions as non-limiting examples. In a first iteration from the user perspective, step 602 can represent a starting point. However, with regard to continuing or improving an ongoing machine learning workflow, step 602 can represent an opportunity for further user input or oversight via a feedback loop.

In step 604, data is received, collected, accessed, or otherwise acquired and entered as can be termed data ingestion. In step 606, the data ingested in step 604 is pre-processed, for example, by cleaning, and/or transformation such as into a format that the following components can digest. The incoming data may be versioned to connect a data snapshot with the particularly resulting trained model. As newly trained models are tied to a set of versioned data, preprocessing steps are tied to the developed model. If new data is subsequently collected and entered, a new model will be generated. If the preprocessing step 606 is updated with newly ingested data, an updated model will be generated. Step 606 can include data validation, which focuses on confirming that the statistics of the ingested data are as expected (e.g., to confirm that data values are within expected numerical ranges, that data sets are within any expected or required categories, and that data comply with any needed distributions such as within those categories). Step 606 can proceed to step 608 to automatically alert the initiating user, other human or virtual agents, and/or other systems, if any anomalies are detected in the data, thereby pausing or terminating the process flow until corrective action is taken.

In step 610, training test data such as a target variable value is inserted into an iterative training and testing loop. In step 612, model training, a core step of the machine learning workflow, is implemented. A model architecture is trained in the iterative training and testing loop. For example, features in the training test data are used to train the model based on weights and iterative calculations in which the target variable may be incorrectly predicted in an early iteration as determined by comparison in step 614, where the model is tested. Subsequent iterations of the model training, in step 612, may be conducted with updated weights in the calculations.

When compliance and/or success in the model testing in step 614 is achieved, process flow proceeds to step 616, where model deployment is triggered. The model may be utilized in AI functions and programming, for example to simulate intelligent behavior, to perform machine-assisted or computerized tasks, of which visual perception, speech recognition, decision-making, translation, forecasting, predictive modelling, and/or automated suggestion generation serve as non-limiting examples.

As discussed above, oversight of a deployed machine learning model may be automatically performed via a feedback loop whereby the method assesses performance of the deployed model (see step 616) and the feedback loop automatically provides feedback for further training of the machine learning model to improve its performance, and upon completion of the other method steps such as 612, the machine learning model that has been automatically retrained based on the feedback loop is then redeployed (step 614). In some embodiments, the system is continually receiving training data as new predictions are made and more data is collected. The continuous training data may be discretized to generate input data to retrain the model. Discretization methods can convert continuous data to discrete data by binning, clustering, and numerical discretization. The model may monitor incoming data sets to make predictions. When predictions are made the system analyzes the predictions to determine whether the model needs to be retrained.

In some embodiments, the model may detect anomalies in the predictions. Anomaly detection can provide a benefit by identifying instances of the prediction that deviate from expected data or a general pattern. A difficulty in anomaly detection is that the system must define the boundary between ordinary data and anomalous data to accurately classify the data as ordinary or anomalous. The line between ordinary and anomalous may be difficult to determine with cases approaching a boundary and based on the specific application. For example, small variations may trigger an identification of an anomaly in the data while relatively larger deviations may be considered normal in less sensitive applications. The disclosed systems and methods may provide solutions to detecting anomalies in order to more accurately and quickly determine whether a model needs to be retrained. If data would be inapplicable or would corrupt the model by reducing the quality of the input data or training process (e.g., due to missing values, outliers, inconsistent formatting, incorrect labels, noisy data, etc.) that data may be automatically dropped and the source of that data may be blocked from providing data that would be used to train the model. This reflects an improvement in the process of training and deploying a model that is accurate and specific to the type of prediction sought. In particular, this provides an improvement in the field of model training, which provides a practical application.

In other applications, the anomaly detections processes described herein may be used to provide enhanced security to the overall computing system by detecting compliance gaps such as vulnerabilities in system security. For example, the system may take proactive measures to remediate danger by rectifying the one or more compliance gaps to remedy the security vulnerability. For example, the system may identify compliance gaps associated with encryption requirements and may remedy the encryption process to reduce the likelihood that data may be compromised, which provides an improvement in network security.

The systems and methods disclosed herein may also be used to analyze text to form the predictions. In particular, the systems and methods described herein include a combination of elements that are utilized in a specific manner for automatically performing automated processes based on technological efficiency, which provides a specific improvement over prior art systems resulting in improved computer processing for faster automated processing functions. For example, the systems and method may apply process automation for digital transformation of the data based on specific criteria to interpret text and unstructured data using text processing software techniques. The interpretation of the text may be implemented using the models described herein including unsupervised learning techniques or supervised learning techniques. The processor may track how much memory and/or processing time has been allocated to perform a function and the system may be trained to automatically detect and identify processes eligible for increased efficiencies based on existing inefficiencies in the process.

For example, the machine learning models may use unsupervised learning to identify and characterize hidden structures of unstructured and unlabeled content data, or supervised techniques that operate on labeled content data and include instructions informing the system which outputs are related to specific input values. In such instances, software processing can rely on iterative training techniques and training data to configure neural networks with an understanding of individual words, phrases, subjects, sentiments, and parts of speech.

Supervised learning software systems are trained using content data that is labeled or “tagged.” During training, the supervised software systems learn the best mapping function between a known data input and expected known output (i.e., labeled or tagged content data). Supervised natural language processing software then uses the best approximating mapping learned during training to analyze unforeseen input data (never seen before) to accurately predict the corresponding output. Supervised learning software systems often require extensive and iterative optimization cycles to adjust the input-output mapping until they converge to an expected and well-accepted level of performance, such as an acceptable threshold error rate between a calculated probability and a desired threshold probability.

The software systems are supervised because the way of learning from training data mimics the same process of a teacher supervising the end-to-end learning process. Supervised learning software systems are typically capable of achieving excellent levels of performance, but this excellent level of performance requires labeled data to be available. Developing, scaling, deploying, and maintaining accurate supervised learning software systems can take significant time, resources, and technical expertise from a team of skilled data scientists. Moreover, precision of the systems is dependent on the availability of labeled content data for training that is comparable to the corpus of content data that the system will process in a production environment.

Supervised learning software systems implement techniques that include, without limitation, Latent Semantic Analysis (“LSA”), Probabilistic Latent Semantic Analysis (“PLSA”), Latent Dirichlet Allocation (“LDA”), and more recent Bidirectional Encoder Representations from Transformers (“BERT”). Latent Semantic Analysis software processing techniques process a corporate of content data files to ascertain statistical co-occurrences of words that appear together, which then give insights into the subjects of those words and documents.

Unsupervised learning software systems can perform training operations on unlabeled data and less requirement for time and expertise from trained data scientists. Unsupervised learning software systems can be designed with integrated intelligence and automation to automatically discover information, structure, and patterns from content data. Unsupervised learning software systems can be implemented with clustering software techniques that include, without limitation, K-means clustering, Mean-Shift clustering, Density-based clustering, Spectral clustering, Principal Component Analysis, and Neural Topic Modeling (“NTM”).

Clustering software techniques can automatically group semantically similar words together to accelerate the derivation and verification of an underneath common intent—i.e., ascertain or derive a new classification or subject, and not just classification into an existing subject or classification. Unsupervised learning software systems are also used for association rules mining to discover relationships between features from content data.

The content driver software service utilizes one or more supervised or unsupervised software processing techniques to perform a subject classification analysis to generate subject data. Suitable software processing techniques can include, without limitation, Latent Semantic Analysis, Probabilistic Latent Semantic Analysis, Latent Dirichlet Allocation. Latent Semantic Analysis software processing techniques generally process a corpus of alphanumeric text files, or documents, to ascertain statistical co-occurrences of words that appear together, which then give insights into the subjects of those words and documents. The content driver software service can utilize software processing techniques that include Non-Matrix Factorization, Correlated Topic Model (“CTM”), and K-Means or other types of clustering.

The systems and methods disclosed herein may utilize or otherwise incorporate natural language understanding and natural language generation functionalities. Neural networks may be trained using training set content data that comprise sample tokens, phrases, sentences, paragraphs, or documents for which desired subjects, content sources, interrogatories, or sentiment values are known. A labeling analysis may be performed on the training set content data to annotate the data with known subject labels, interrogatory labels, content source labels, or sentiment labels, thereby generating annotated training set content data. For example, a person can utilize a labeling software application to review training set content data to identify and tag or “annotate” various parts of speech, subjects, interrogatories, content sources, and sentiments.

The training set content data may then be fed to the content driver software service neural networks to identify subjects, content sources, or sentiments and the corresponding probabilities. For example, the analysis might identify that particular text represents a question with a 35% probability. If the annotations indicate the text is, in fact, a question, an error rate can be taken to be 65% or the difference between the calculated probability and the known certainty. Then parameters to the neural network are adjusted (i.e., constants and formulas that implement the nodes and connections between node), to increase the probability from 35% to ensure the neural network produces more accurate results, thereby reducing the error rate. The process is run iteratively on different sets of training set content data to continue to increase the accuracy of the neural network.

The content data is first pre-processes using a reduction analysis to create reduced content data. The reduction analysis first performs a qualification operation that removes unqualified content data that does not meaningfully contribute to the subject classification analysis. The qualification operation removes certain content data according to criteria defined by a provider. For instance, the qualification analysis can determine whether content data files are “empty” and contain no recorded linguistic interaction between a provider agent and a user and designate such empty files as not suitable for use in a subject classification analysis. As another example, the qualification analysis can designate files below a certain size below a given threshold (e.g., less than one minute) as also being unsuitable for use in the subject classification analysis.

The reduction analysis can also perform a contradiction operation to remove contradictions and punctuations from the content data. Contradictions and punctuation include removing or replacing abbreviated words or phrases that can cause inaccuracies in a subject classification analysis. Examples include removing or replacing the abbreviations “min” for minute, “u” for you, and “wanna” for “want to,” as well as apparent misspellings, such as “mssed” for the word missed. In some embodiments, the contradictions can be replaced according to a standard library of known abbreviations, such as replacing the acronym “brb” with the phrase “be right back.” The contradiction operation can also remove or replace contractions, such as replacing “we're” with “we are.” The reduction analysis can also streamline the content data by performing one or more of the following operations, including: (i) tokenization to transform the content data into a collection of words or key phrases having punctuation and capitalization removed; (ii) stop word removal where short, common words or phrases such as “the” or “is” are removed; (iii) lemmatization where words are transformed into a base form, like changing third person words to first person and changing past tense words to present tense; (iv) stemming to reduce words to a root form, such as changing plural to singular; and (v) hyponymy and hypernym replacement where certain words are replaced with words having a similar meaning so as to reduce the variation of words within the content data.

Following a reduction analysis, the reduced content data is vectorized to map the alphanumeric text into a vector form. One approach to vectorizing content data includes applying “bag-of-words” modeling. The bag-of-words approach counts the number of times a particular word appears in content data to convert the words into a numerical value. The bag-of-words model can include parameters, such as setting a threshold on the number of times a word must appear to be included in the vectors.

Techniques to encode the context communication elements (e.g., such as words, speech patterns, tone, timbre, cadence, etc.) may, in part, determine how often communication elements appear together. Determining the adjacent pairing of communication elements can be achieved by creating a co-occurrence matrix with the value of each member of the matrix counting how frequently one communication element coincides with another, either just before or just after it. That is, the words or communication elements form the row and column labels of a matrix, and a numeric value appears in matrix elements that correspond to a row and column label for communication elements that appear adjacent in the content data.

As an alternative to counting communication elements (e.g., words) in a corpus of content data and turning it into a co-occurrence matrix, another software processing technique may be used where a communication element in the content data corpus predicts the next communication element. Looking through a corpus, counts may be generated for adjacent communication elements, and the counts are converted from frequencies into probabilities (i.e., using n-gram predictions with Kneser-Ney smoothing) using a simple neural network. Suitable neural network architectures for such purpose include a skip-gram architecture. The neural network may be trained by feeding through a large corpus of content data, and embedded middle layers in the neural network are adjusted to best predict the next word.

The predictive processing creates weight matrices that densely carry contextual, and hence semantic, information from the selected corpus of content data. Pre-trained, contextualized content data embedding can have high dimensionality. To reduce the dimensionality, a uniform manifold approximation and projection algorithm (“UMAP”) can be applied to reduce dimensionality while maintaining essential information.

Prior to conducting a subject analysis to ascertain subject identifiers in the content data (i.e., topics or subjects addressed in the content data) or interaction driver identifiers in the content data (i.e., reasons why the customer initiated the interaction with the provider, such as the reason underlying a support request), the system can perform a concentration analysis on the content data. The concentration analysis concentrates, or increases the density of, the content data by identifying and retaining communication elements that have significant weight in the subject analysis and discarding or ignoring communication elements that have relativity little weight.

In one embodiment, the concentration analysis includes executing a term frequency- inverse document frequency (“tf-idf”) software processing technique to determine the frequency or corresponding weight quantifier for communication elements with the content data. The weight quantifiers are compared against a pre-determined weight threshold to generate concentrated content data that is made up of communication elements having weight quantifiers above the weight threshold.

The concentrated content data is processed using a subject classification analysis to determine subject identifiers (i.e., topics) addressed within the content data. The subject classification analysis can specifically identify one or more interaction driver identifiers that are the reason why a user initiated a shared experience or support service request. An interaction driver identifier can be determined by, for example, first determining the subject identifiers having the highest weight quantifiers (e.g., frequencies or probabilities) and comparing such subject identifiers against a database of known interaction driver identifiers.

In one embodiment, the subject classification analysis is performed on the content data using a Latent Dirichlet Allocation analysis to identify subject data that includes one or more subject identifiers (e.g., topics addressed in the underlying content data). Performing the LDA analysis on the reduced content data may include transforming the content data into an array of text data representing key words or phrases that represent a subject (e.g., a bag-of-words array) and determining the one or more subjects through analysis of the array. Each cell in the array can represent the probability that given text data relates to a subject. A subject is then represented by a specified number of words or phrases having the highest probabilities (i.e., the words with the five highest probabilities), or the subject is represented by text data having probabilities above a predetermined subject probability threshold.

Clustering software processing techniques include K-means clustering, which is an unsupervised processing technique that does not utilized labeled content data. Clusters are defined by “K” number of centroids where each centroid is a point that represents the center of a cluster. The K-means processing technique run in an iterative fashion where each centroid is initially placed randomly in the vector space of the dataset, and the centroid moves to the center of the points that is closest to the centroid. In each new iteration, the distance between each centroid and the points are recalculated, and the centroid moves again to the center of the closest points. The processing completes when the position or the groups no longer change or when the distance in which the centroids change does not surpass a pre-defined threshold.

The clustering analysis yields a group of words or communication elements associated with each cluster, which can be referred to as subject vectors. Subjects may each include one or more subject vectors where each subject vector includes one or more identified communication elements (i.e., keywords, phrases, symbols, etc.) within the content data as well as a frequency of the one or more communication elements within the content data. The content driver software service can be configured to perform an additional concentration analysis following the clustering analysis that selects a pre-defined number of communication elements from each cluster to generate a descriptor set, such as the five or ten words having the highest weights in terms of frequency of appearance (or in terms of the probability that the words or phrases represent the true subject when neural networking architecture is used). In one embodiment, the descriptor sets were analyzed to determine if the reasons driving a customer support request were identified by the descriptor set subject identifiers.

The software model may be evaluated according to three categories, including a “good match” where the support request reason(s) are identified by the top words in the subject vector (i.e., the words with the highest weight or frequency), a “moderate” match where the support request reason(s) are identified by the second tier of words in the subject vector (i.e., words six to ten), and a “poor” match where, for instance, the top words in a subject vector do not match or identify the reasons the support request was initiated.

Alternatively, instead of selecting a pre-determined number of communication elements, post-clustering concentration analysis can analyze the subject vectors to identify communication elements that are included in several subject vectors having a weight quantifier (e.g., a frequency) below a specified weight threshold level that are then removed from the subject vectors. In this manner, the subject vectors are refined to exclude content data less likely to be related to a given subject. To reduce an effect of spam, the subject vectors may be analyzed, such that if one subject vector is determined to include communication elements that are rarely used in other subject vectors, then the communication elements are marked as having a poor subject correlation and is removed from the subject vector.

In another embodiment, the concentration analysis is performed on unclassified content data by mapping the communication elements within the content data to integer values. The content data is thus turned into a bag-of-words that includes integer values and the number of times the integers occur in content data. The bag-of-words is turned into a unit vector, where all the occurrences are normalized to the overall length. The unit vector may be compared to other subject vectors produced from an analysis of content data by taking the dot product of the two-unit vectors. All the dot products for all vectors in a given subject are added together to provide a weighting quantifier or score for the given subject identifier, which is taken as subject weighting data. A similar analysis can be performed on vectors created through other processing, such as K-means clustering or techniques that generate vectors where each word in the vector is replaced with a probability that the word represents a subject identifier or request driver data.

In one example, text mapping may be applied to a data processing workflow to categorize the text to one or more topological vector spaces, wherein each respective vector space of the one or more topological vector spaces includes associated rule functions. A topological vector space is a vector space over a topological field that is provided with topological features of the text using underlying representations of words for text classification.

To illustrate generating subject weighting data, for any given subject there may be numerous subject vectors. Assume that for most of subject vectors, the dot product will be close to zero—even if the given content data addresses the subject at issue. Since there are some subjects with numerous subject vectors, there may be numerous small dot products that are added together to provide a significant score. Put another way, the particular subject is addressed consistently throughout a document, several documents, sessions of the content data, and the recurrence of the carries significant weight.

In another embodiment, a predetermined threshold may be applied where any dot product that has a value less than the threshold is ignored and only stronger dot products above the threshold are summed for the score. In another embodiment, this threshold may be empirically verified against a training data set to provide a more accurate subject analysis.

In another example, a number of subject identifiers may be substantially different, with some subjects having orders of magnitude fewer subject vectors than do other subjects. The weight scoring might significantly favor relatively unimportant subjects that occur frequently in the content data. To address this problem, a linear scaling on the dot product scoring based on the number of subject vectors may be applied. The result provides a correction to the score so that important but less common subjects are weighed more heavily.

Once all scores are calculated for all subjects, then subjects may be sorted, and the most probable subjects are returned. The resulting output provides an array of subjects and strengths. In another embodiment, hashes may be used to store the subject vectors to provide a simple lookup of text data (e.g., words and phrases) and strengths. The one or more subject vectors can be represented by hashes of words and strengths, or alternatively an ordered byte stream (e.g., an ordered byte stream of 4-byte integers, etc.) with another array of strengths (e.g., 4-byte floating-point strengths, etc.).

The content driver software service can also use term frequency-inverse document frequency software processing techniques to vectorize the content data and generating weighting data that weight words or particular subjects. The tf-idf is represented by a statistical value that increases proportionally to the number of times a word appears in the content data. This frequency is offset by the number of separate content data instances that contain the word, which adjusts for the fact that some words appear more frequently in general across multiple shared experiences or content data files. The result is a weight in favor of words or terms more likely to be important within the content data, which in turn can be used to weigh some subjects more heavily in importance than others. To illustrate with a simplified example, the tf-idf might indicate that the term “password” carries significant weight within content data. To the extent any of the subjects identified by a natural language processing analysis include the term “password,” that subject can be assigned more weight by the content driver software service.

The content data can be visualized and subject to a reduction into two-dimensional data using a UMAP to generate a cluster graph visualizing a plurality of clusters. The content driver software service feeds the two-dimensional data into a DBSCAN and identify a center of each cluster of the plurality of clusters. The process may, using the two-dimensional data from the UMAP and the center of each cluster from the DBSCAN, apply a KNN to identify data points closest to the center of each cluster and shade each of the data points to graphically identify each cluster of the plurality of clusters. The processor may illustrate a graph on the display representative of the data points that are shaded following application of the KNN.

The content driver software service can also incorporate Part of Speech (“POS”) tagging software code that assigns words a part of speech depending upon the neighboring words, such as tagging words as a noun, pronoun, verb, adverb, adjective, conjunction, preposition, or other relevant parts of speech. The content driver software service can utilize the POS tagged words to help identify questions and subjects according to pre-defined rules, such as recognizing that the word “what” followed by a verb is also more likely to be a question than the word “what” followed by a preposition or pronoun (e.g., “What is this?”versus “What he wants is an answer.”).

POS tagging in conjunction with Named Entity Recognition (“NER”) software processing techniques can be used by the content driver software service to identify various content sources within the content data. NER techniques are utilized to classify a given word into a category, such as a person, product, organization, or location. Using POS and NER techniques to process the content data allow the content driver software service to identify particular words and text as a noun and as representing a person participating in the discussion (e.g., a content source).

The systems and methods disclosed herein may utilize deployed models (i.e., machine learning models, neural networks, predictive models, etc.) to make predictions about text in order to perform software control. The use of specially trained models realizes a number of improvements over traditional methods of software controls, including more accurate and uniform compliance with respect to a predefined risk posture of an entity and government regulations through providing uniform controls and review processes. Advantageously, the systems improve error detection associated with non-compliance. Further, the systems and methods disclosed herein lead to faster training times and a more accurate model.

Organizations have a need for design and development of new software technologies at scale. Disclosed herein are systems and methods that improve systemic performance of data product design and development by utilizing a customized knowledge domain framework. An end user may desire to create their own knowledge domain by uploading internal organizational documents so that these documents can be incorporated into generative artificial intelligence model development. However, existing systems would require significant time and resources in order to create that process flow. The systems and methods disclosed herein eliminate much of the development time and resource investment.

The customized knowledge domain framework provides a repository of knowledge specific to certain teams, subgroups, and/or entire organizations depending on the permissions for accessing the documentation. The customized knowledge domain framework allows a knowledge domain expert to create a grounding layer for a new generative artificial intelligence model or other data process where the grounding layer is specific to a grouping of individuals with certain access permissions.

The customized knowledge domain framework provides a mechanism by which knowledge domain experts can readily design and build out models for training using the methods described herein with reference to FIGS. 2A-6. For example, the customized knowledge domain framework may enable end users to submit training data through a corpus of documents that the customized knowledge domain framework then receives and uses to train a model. The customized knowledge domain framework may receive instructions from the knowledge domain expert on whether the model should utilize backpropagation algorithms and/or gradient descent algorithms to train the model. Gradient descent may be used by the model being created to differentiate real-valued multivariate functions by applying a gradient descent calculation to values and parameters to iteratively adjust the values to minimize a loss function and optimize the model. Backpropagation may be incorporated into the model to calculate the derivatives and gradient of the error function of the weights applied to the neurons within a neural network or model being generated by the customized knowledge domain framework. The corpus of documents selected or provided by the knowledge domain expert may include historical data that the customized knowledge domain framework may utilize. In some use cases, the models generated by the customized knowledge domain framework may be programmed to discretize continuous data into discrete data using, for example, binning clustering, or numerical discretization so that the data can be counted and measured.

One of the advantages provided by the customized knowledge domain framework is that it allows a knowledge domain expert to impart knowledge from a corpus of documents that can be in any format, and the system can utilize structured data, unstructured data, and linked data products to standardized the information for use in developing a model. This standardization may be performed in real time so that users can quickly and efficiently generate the model.

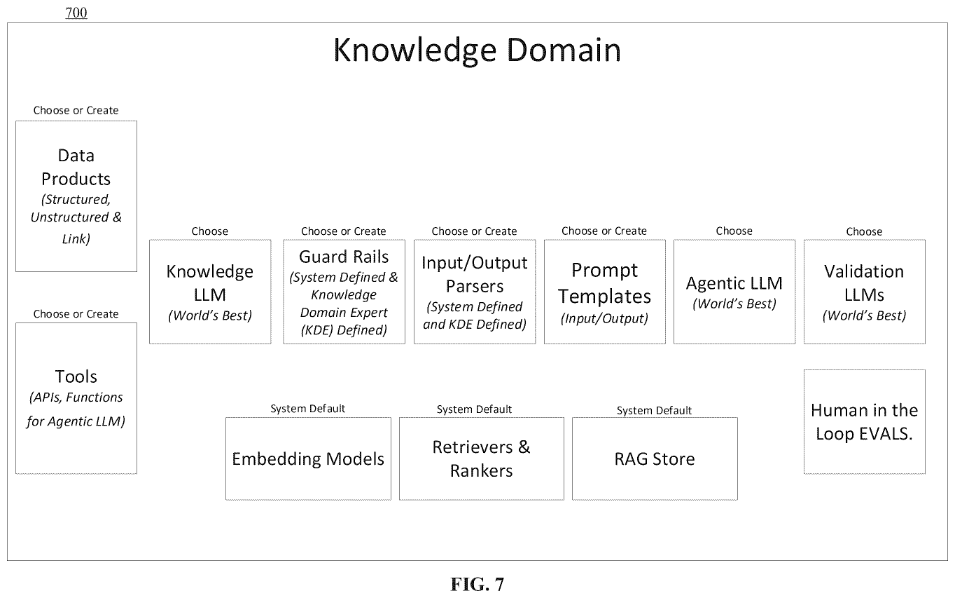

FIG. 7 depicts an example customized knowledge domain framework 700, according to one embodiment. A number of documents and/or data products are provided in order to initiate creating of a customized knowledge domain framework for a specific subgroup or grouping of individuals within an entity. In some embodiments, access to the documents and/or data products may be restricted such that only certain individuals may have access to the generative artificial intelligence model produced using documents and/or data products in which access is restricted.

The customized knowledge domain framework is developed to enable the rapid development and deployment of generative artificial intelligence (AI) applications at scale. The customized knowledge domain framework can help knowledge domain experts create AI applications and components using an internal knowledge domain. A few examples of knowledge domains (KDs) include Policy KD, Teammate Benefits KD, Customer Deposit Trends KD, Wealth Advisors KD, Fixed Income Front Office KD, etc.

The customized knowledge domain framework can help knowledge domain experts (KDEs) choose or create structured, unstructured, and linked data products that establish the grounding layer and underlying foundation through an internal corpus of documents used to create a new generative AI application, APIs, and/or functions of an agentic large language model (LLM). The customized knowledge domain framework provides access to selected knowledge LLMs, which can be chosen from existing publicly available LLMs. For example, a curated list of LLMs would be made available that would be supported with secure APIs. The KDE could have information available through the customized knowledge domain framework to help in the selection application where the information describes the potential benefits and/or downsides associated with a given LLM relevant to the specific use case.

The guardrails are selectable metadata that KDEs can define for a new application. The guardrails set the boundaries for use of the new application in order to define how new information is captured and the application should be deployed. Advantageously, the guardrails manage risk and reduce harm that can be introduced through the new application. The guardrails may be developed by the KDEs that provide descriptive comments on use and deployment that make up the metadata for the new application, which the customized knowledge domain framework captures. Guardrails can include specific metrics, such as relevance, coherence, and Ada similarity (i.e. OpenAI Ada). Guardrails can also provide integration into an organization's AI governance platforms and tools.

Parsers can include input/output parsers, which can be system defined by the customized knowledge domain framework and/or defined by KDEs. Input parsers help in parsing unstructured content. A digital parser is used to parse content from HTML and PDF files. An optical character recognition (OCR) parser is used to parse PDF content with images and Layout parser is recommended when you have rich content and structural elements like sections, paragraphs, tables, lists to be extracted from documents for search and answer generation. Output parsers help to take the output from the new application and parses the information from the AI model into a more structured format.

Prompt templates can include input/output templates that provide users of the AI model with guidance on how to use the model. The prompt templates can be used by KDEs so that the inputs provided by end users of the model will be relevant and consistent. The prompt templates that are chosen and created by the KDEs will continually be expanding as more AI models are developed and more applications are created.

The customized knowledge domain framework would also make the operative connections with the world's best agentic language learning models. Agents powered by the agentic LLMs can interact with other agents from other LLMs to perform tasks with minimal human intervention while providing human-like reasoning capabilities. Agentic LLMs can be used to automate complex workflows in various business contexts.

The validation LLMs can be selected by the KDE from the world's best validation LLMs. The validation LLMs are responsible for validating the outputs of the AI models created through the customized knowledge domain framework, thereby ensuring accuracy, relevance, and reliability of the generated AI models. The validation LLMs assist in quality assurance of the AI model outputs within the customized knowledge domain framework, thereby providing additional layer of verification for AI driven tasks. The validation screen would be capable of offering self-review of whether the AI model that is generated and developed is working as intended as well as a peer review option to allow end-users to submit feedback on the quality and functionality of the AI model that is developed.

The customized knowledge domain framework may be programmed to provide default settings to KDEs if the KDE is unsure of which option to select for generating an AI model or new application. The system defaults can include embedded models, retrievers and rankers, and a retrieval-augmented generation (RAG) store. The RAG grounding documents may be automatically updated by the system as new material is required or introduced. The defaults can give the organization some control over the incorporation of certain foundational AI models, LLMs, and other generated model types. Role-based access control (RBAC) can be used to restrict network access based on an individual's role within an organization to define the underlying corpus of documents that can be used by a KDE to create an AI model. The RBAC can be integrated into an identity and access management framework utilized by the customized knowledge domain framework through a single sign-on (SSO) authentication method. The system may also provide an enhanced user interface for root user access.

In some cases, the KDEs can utilize the customized knowledge domain framework for API selection or creation. In other cases, the KDEs can utilize the customized knowledge domain framework for selection or creation of functions for agentic LLMs. The customized knowledge domain framework may incorporate a user interface design for internal use by an organization. The customized knowledge domain framework may be accessed by different individuals within the organization including creators, administrators, end users, validators, monitors, governance individuals, auditors, and developers. Initially upon access of a landing page of the user interface for the customized knowledge domain framework, the user may select their role for utilizing the customized knowledge domain framework. Governance of the customized knowledge domain framework may be provided through a governance user interface so that the customized knowledge domain framework for logging, monitoring, and overriding activity on the customized knowledge domain framework. Within the customized knowledge domain framework, the capabilities are API driven.

In some embodiments, the KDE can use the customized knowledge domain framework to create a custom depository of knowledge. The customized knowledge domain framework may be used to generate an agent and other functions for agentic large language models. The agentic large language models may examine historical patterns of a given user's use of the customized knowledge domain framework and can provide recommendations for creating functions for agentic large language models and/or a generative artificial intelligence application. The user can select or create certain data products (e.g., four data products) for use as the corpus of documents used to train the generative artificial intelligence application and/or agentic large language models.

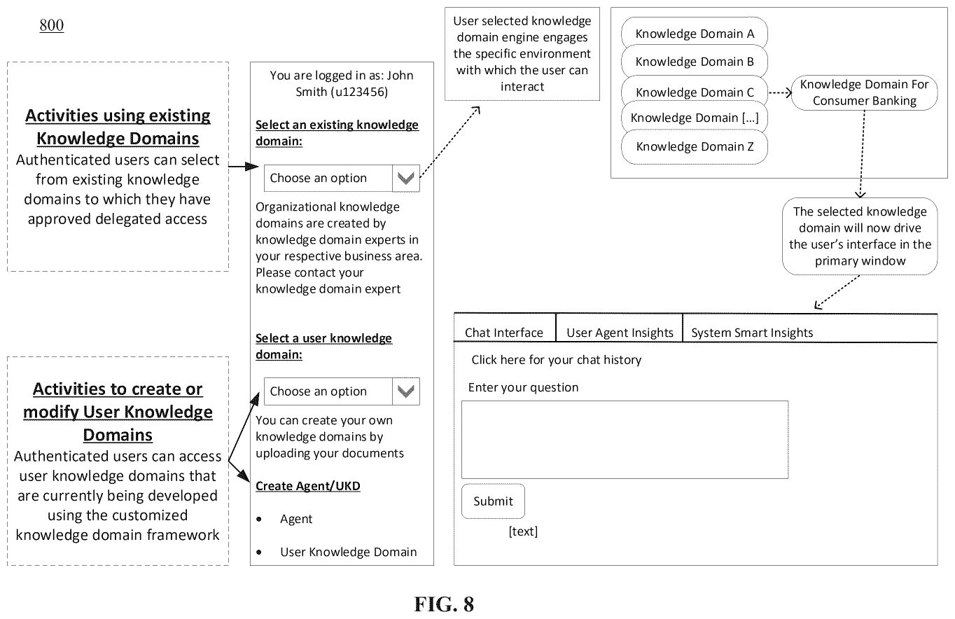

FIG. 8 depicts an example schematic 800 for AI model development, in accordance with an embodiment of the present invention. The knowledge domain framework may be utilized by knowledge domain experts to create components for various lines of business. Knowledge domains that may be created for the lines of business can include policy knowledge domains, teammate benefits knowledge domain, a knowledge domain on customer deposit trends, a knowledge domain for wealth advisors, a knowledge domain on front office functions, etc. Once the knowledge domain is chosen or created, the knowledge domain expert can set permissions for which individuals within the organization can access the knowledge domain. End users within certain lines of business can access certain knowledge domains that are authorized based on their line of business and/or access level to create AI models within a secure and sustainable environment for new innovation opportunities. System administrators provide comprehensive safeguards and controls that ensure the ethical, secure, and compliant use of AI systems. The guardrails intercept and evaluate user prompts/inputs provided via the chatbot by the end users before they reach the AI model. In particular, the guardrails monitor and block prompts that violate predefined rules. As new Guardrails are developed by KDEs, metadata including descriptive comments on use and deployment are captured by the knowledge domain framework. The knowledge domain framework also incorporates RBAC through an identity and access management framework.

The knowledge domain experts build the knowledge domain for their respective line of business functions by selecting data products, selecting the large language models, and submitting data for building a RAG-based knowledge system. Once the knowledge domain experts build a knowledge domain for a respective line of business, users with authorized access to specific knowledge domains can perform activities to create and modify user knowledge domains. User knowledge domains, allow users to upload documents with unstructured data (e.g., PDFs, text documents, multimedia files, etc.) to set up their own user knowledge domain. A user knowledge domain enables a user to use the documents that they upload as part of their user knowledge domain so that those documents can be used by the chat interface as a knowledge source to provides responses to user inputs. The end user of the knowledge domain framework also allows users to choose stored knowledge domains for the chatbot interactions via the chat interface. The chat interface provides front-end application capabilities to enable retrieval-augmented interactions with a large language model. The chat interface may be cloud-based, on-premises, or a combination thereof.

The platform design for the knowledge domain framework incorporates a unique architecture and design that defines the components of integration. The knowledge domain experts design the user interface and functionality by creating write frames for domain management and navigation. During the buildout of the knowledge domain framework, the platform is tested and evaluated for intuitive navigation and option selection. The buildout may also incorporate user acceptance testing to ensure the design meets the technological and business requirements. Development of the knowledge domain framework may incorporate unit testing, smoke testing, and quality assurance checks. Defects may be managed through defect identification, documentation, root cause analysis, and resolution.

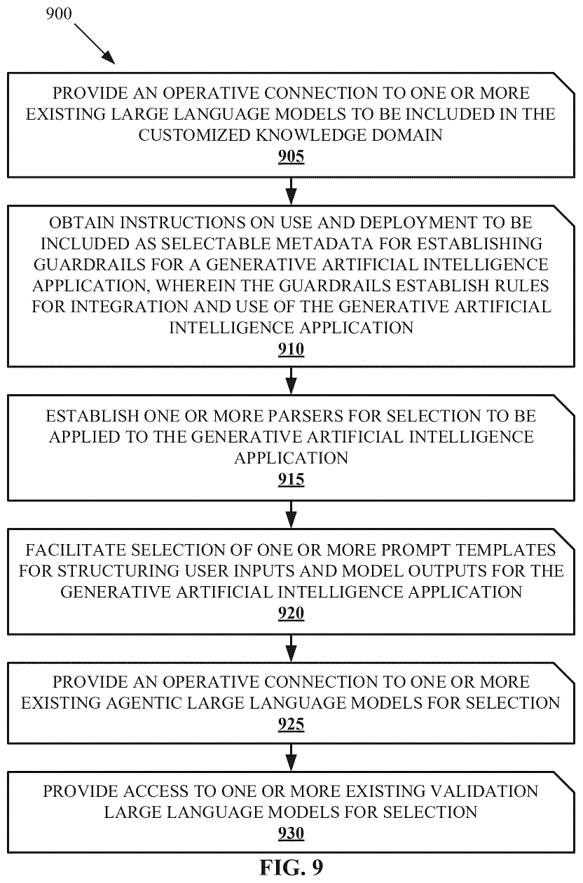

FIG. 9 depicts a block diagram of an example method 900 for developing a customized knowledge domain framework, in accordance with an embodiment of the present invention. At block 905, the system provides an operative connection to one or more existing large language models to be included in the customized knowledge domain framework. At block 910, the system obtains instructions on use and deployment to be included as selectable metadata for establishing guardrails for a generative artificial intelligence application, wherein the guardrails establish rules for integration and use of the generative artificial intelligence application. At block 915, the system establishes one or more parsers for selection to be applied to the generative artificial intelligence application. At block 920, the system facilitates selection of one or more prompt templates for structuring user inputs and model outputs for the generative artificial intelligence application. At block 925, the system provides an operative connection to one or more existing agentic large language models for selection. At block 930, the system provides access to one or more existing validation large language models for selection. In some embodiments, the one or more existing large language models are selected from a curated list of existing large language models, the one or more existing large language models being support with one or more secure application programming interfaces. In some embodiments, the rules include at least one selected from the group consisting of relevance, coherence, an Ada similarity score, and integration capabilities in relation to an entity's governance platforms. In some embodiments, the one or more parsers include input parsers for parsing unstructured content for inclusion in the generative artificial intelligence application. In some embodiments, the input parsers are configured to parse one or more files selected from the group consisting of HTML files and PDF files. In some embodiments, the input parsers are selected from the group consisting of an optical character recognition (OCR) parser and a layout parser. In some embodiments, the one or more parsers include output parsers, the output parsers being configured to parse an output from the generative artificial intelligence application and parse the output into a structured format. In some embodiments, the method 800 also includes receiving an input indicating a corpus of documents to be included within the customized knowledge domain framework of an entity and based thereon apply the corpus of documents to one or more custom neural document models that combine language and layout features to extract labeled fields from the corpus of documents, the one or more custom neural document models being trained on a plurality of document types such that the labeled fields are extractable from structured, unstructured, and linked data products.

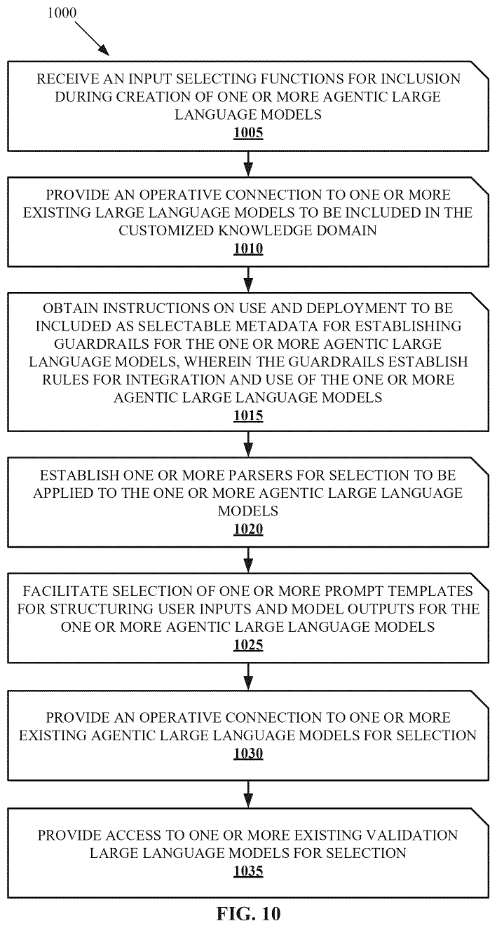

FIG. 10 depicts a block diagram of an example method 1000, in accordance with an embodiment of the present invention. At bock 1005, the system receives an input selecting APIs and functions for inclusion during creation of one or more agentic large language models. At block 1010, the system provides an operative connection to one or more existing large language models to be included in the customized knowledge domain. At block 1015, the system obtains instructions on use and deployment to be included as selectable metadata for establishing guardrails for the one or more agentic large language models, wherein the guardrails establish rules for integration and use of the one or more agentic large language models. At block 1020, the system establishes one or more parsers for selection to be applied to the one or more agentic large language models. At block 1025, the system facilitates selection of one or more prompt templates for structuring user inputs and model outputs for the one or more agentic large language models. At block 1030, the system provides an operative connection to one or more existing agentic large language models for selection. At block 1035, the system provides access to one or more existing validation large language models for selection.

In some embodiments, the one or more existing large language models are selected from a curated list of existing large language models, the one or more existing large language models being supported with one or more secure application programming interfaces. In some embodiments, the rules include at least one selected from the group consisting of relevance, coherence, an Ada similarity score, and integration capabilities in relation to the entity's governance platforms. In some embodiments, the one or more parsers include input parsers for parsing unstructured content for inclusion in the one or more large language models, wherein the one or more large language models are agentic large language models. In some embodiments, the input parsers are configured to parse one or more files selected from the group consisting of HTML files and PDF files. In some embodiments, the input parsers are selected from the group consisting of an optical character recognition (OCR) parser and a layout parser. In some embodiments, the one or more parsers include output parsers, the output parsers being configured to parse an output from the one or more agentic large language models and parse the output into a structured format. In some embodiments, the method 1000 also includes receiving an input indicating a corpus of documents to be included within the customized knowledge domain framework of an entity and based thereon apply the corpus of documents to one or more custom neural document models that combine language and layout features to extract labeled fields from the corpus of documents, the one or more custom neural document models being trained on a plurality of document types such that the labeled fields are extractable from structured, unstructured, and linked data products.

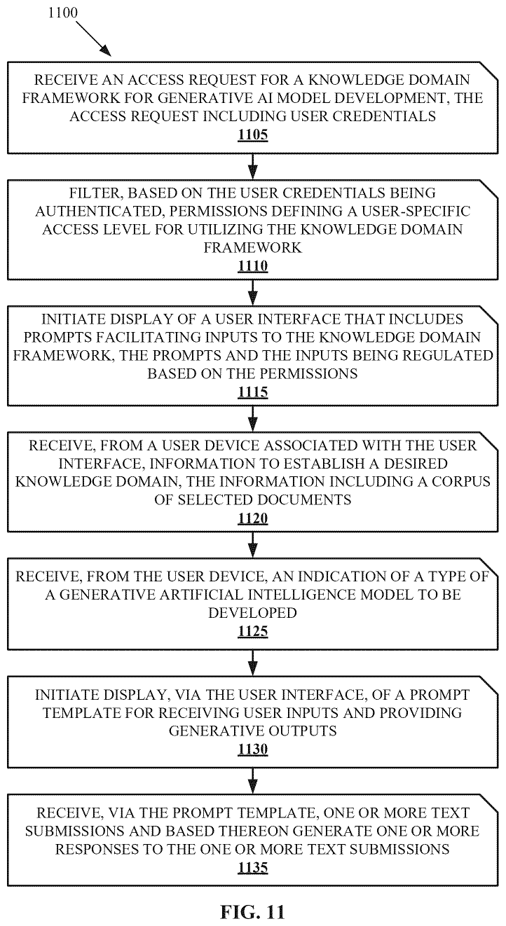

FIG. 11 depicts a block diagram of an example method 1100, in accordance with an embodiment of the present invention. At block 1105, the system receives an access request for a knowledge domain framework for generative AI model development, the access request including user credentials. At block 1110, the system filters, based on the user credentials being authenticated, permissions defining a user-specific access level for utilizing the knowledge domain framework. In some embodiments, the user-specific access level is based on organizational operation policies and a line of business of a user that is associated with the user credentials. In some embodiments, the permissions provide role-based access control that defines guardrails that include controls for performing the regulating the prompts for ethics, security, and compliance purposes.

At block 1115, the system initiates display of a user interface that includes prompts facilitating inputs to the knowledge domain framework, the prompts being regulated based on the permissions. At block 1120, the system receives, from a user device associated with the user interface, information to establish a desired knowledge domain (i.e., a user knowledge domain), the desired knowledge domain including a corpus of selected documents. In some embodiments, the information to establish the desired knowledge domain includes a submission of the corpus of selected documents. Further, the corpus of selected documents may include documents having unstructured data (e.g. a PDF, a text document, a multimedia file, etc.). In some embodiments, the information to establish the desired knowledge domain includes a selection of previously stored documents, the previously stored documents including the corpus of selected documents.

At block 1125, the system receives, from the user device, an indication of a type of a generative artificial intelligence model to be developed, and at block 1130 the system initiates display, via the user interface, of a prompt template for receiving user inputs and providing generative outputs. In some embodiments, the indication of the type of generative artificial intelligence model is associated with one or more types of generative artificial intelligence models available for selection that are filtered based on the permissions. In some embodiments, the user inputs define how the generative artificial intelligence model is to be trained and developed.

In some embodiments, the type of the generative artificial intelligence model is selected from the group consisting of generative adversarial networks, transformer-based models, stable diffusion models, large language models, recurrent neural networks, flow models, neural radiance fields, variational autoencoders, unimodal models, and multimodal models. In some embodiments, the prompt template includes a chat interface functionality, a user agent insights functionality, and a system smart insights functionality. In some embodiments, the prompt template includes a prompt for accessing chat history of a user that is associated with the user credentials. Further, at block 1135, the system receives, via the prompt template, one or more text submissions and based thereon generate one or more responses to the one or more text submissions. In some embodiments, a chatbot generates the one or more responses by utilizing retrieval-augmented interactions leveraging a large language model. In some embodiments, the one or more responses provide information about development of the generative artificial intelligence model. In some embodiments, the method 1100 also includes developing the generative artificial intelligence model and establish API connections for the generative artificial intelligence model for use via the prompt template. In some embodiments, the corpus of selected documents is used to train the generative artificial intelligence model. In some embodiments, the one or more text submissions indicate one or more organizational needs for the generative artificial intelligence model to be developed.

In some embodiments, developing of the generative artificial intelligence model includes iteratively training, using training data comprising the corpus of selected documents, where the corpus of selected documents are associated with a business entity, the generative artificial intelligence model to predict likely answers to one or more questions using the corpus of selected documents such that the likely answers are directed to one or more issues likely to be associated with the business entity. Training of the generative artificial may include inserting the training data into an iterative training and testing loop to predict a target variable, and repeatedly predicting the target variable during each iteration of the training and testing loop, wherein each iteration of the training and testing loop has differing weights applied to one or more nodes of the generative artificial intelligence model, each of the differing weights being updated with each iteration of the training and testing loop to reduce error in predicting the target variable, which improves predictability of the target variable and functionality of the generative artificial intelligence model. The trained generative artificial intelligence model may then be deployed, and accessibility to the deployed generative artificial intelligence model is limited by the user-specific access level for utilizing the knowledge domain framework.

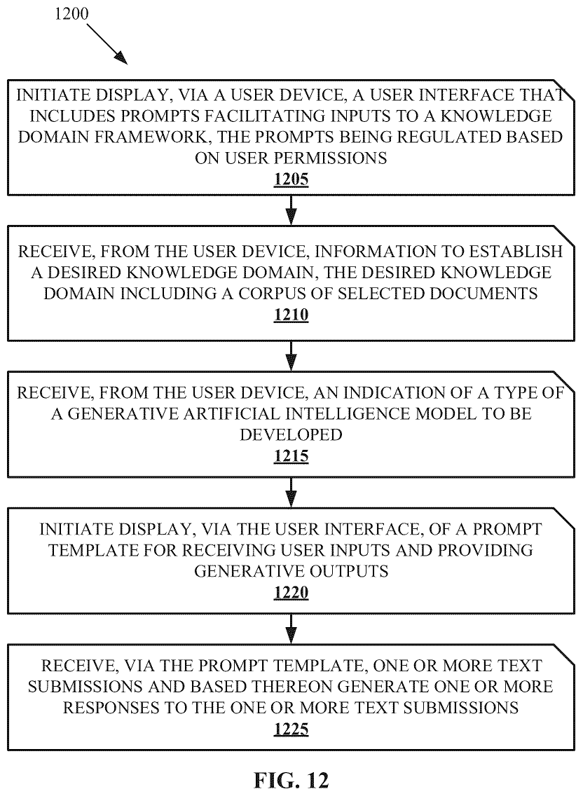

FIG. 12 depicts a block diagram of an example method 1200, in accordance with an embodiment of the present invention. At block 1205, the system initiates display, via a user device, a user interface that includes prompts facilitating inputs to a knowledge domain framework, the prompts being regulated based on user permissions. In some embodiments, the user permissions provide role-based access control that defines guardrails that include controls for performing the regulating the prompts for ethics, security, and compliance purposes. At block 1210, the system receives, from the user device, information to establish a desired knowledge domain, the desired knowledge domain including a corpus of selected documents. In some embodiments, the information to establish the desired knowledge domain includes a submission of the corpus of selected documents. In some embodiments, the information to establish the desired knowledge domain includes a selection of previously stored documents, the previously stored documents including the corpus of selected documents. At block 1215, the system receives, from the user device, an indication of a type of a generative artificial intelligence model to be developed. At block 1220, the system initiates display, via the user interface, of a prompt template for receiving user inputs and providing generative outputs. At block 1225, the system receives, via the prompt template, one or more text submissions and based thereon generate one or more responses to the one or more text submissions. In some embodiments, a chatbot generates the one or more responses by utilizing retrieval-augmented interactions leveraging a large language model. In some embodiments, the method 1200 also includes developing the generative artificial intelligence model and establish API connections for the generative artificial intelligence model for use via the prompt template.

In some embodiments, the indication of the type of the generative artificial intelligence model is associated with one or more types of generative artificial intelligence models available for selection that are filtered based on the user permissions. In some embodiments, the corpus of selected documents is used to train the generative artificial intelligence model. In some embodiments, the user inputs define how the generative artificial intelligence model is to be trained and developed. In some embodiments, the one or more text submissions indicate one or more organizational needs for the generative artificial intelligence model to be developed. In some embodiments, the one or more responses provide information about development of the generative artificial intelligence model. In some embodiments, the corpus of selected documents is filtered based on the user permissions. In some embodiments, the type of the generative artificial intelligence model that can be selected is trained by only using the corpus of selected documents available based on the user permissions. In some embodiments, the corpus of selected documents includes information about entity policies and procedures. In some embodiments, the corpus of selected documents establish limitations for how the generative artificial intelligence model can be used. In some embodiments, the one or more responses to the one or more text submissions are generated by using natural language understanding and natural language generation functionalities of a chatbot.

FIG. 13 depicts a block diagram of an example method 1300, in accordance with an embodiment of the present invention. At block 1305, a computing device obtains, via a user interface of the computing device, user credentials to access a knowledge domain framework. At block 1310, the computing device receives access to the knowledge domain framework, and at block 1315, the computing device displays, via the user interface, prompts facilitating inputs to the knowledge domain framework, the prompts being regulated based on user permissions, the inputs including information to establish a desired knowledge domain, the desired knowledge domain including a corpus of selected documents. At block 1320, the computing device receives, via the user interface, an indication of a type of a generative artificial intelligence model to be developed. At block 1325, the computing device displays, via the user interface, a prompt template for receiving user inputs and providing generative outputs. At block 1330, the computing device receives, via the displayed prompt template, one or more text submissions and transmit the one or more text submissions to a chatbot associated with the knowledge domain framework. At block 1335, the computing devices receives, based the one or more text submissions, one or more responses to the one or more text submissions.

In some embodiments, the information to establish the desired knowledge domain includes a submission of the corpus of selected documents. In some embodiments, the information to establish the desired knowledge domain includes a selection of previously stored documents, the previously stored documents including the corpus of selected documents. In some embodiments, the chatbot generates the one or more responses by utilizing retrieval-augmented interactions leveraging a large language model. In some embodiments, the user permissions provide role-based access control that defines guardrails that include controls for performing the regulating the prompts for ethics, security, and compliance purposes. In some embodiments, the indication of the type of the generative artificial intelligence model to be developed initiates establishing API connections for the generative artificial intelligence model for use via the prompt template. In some embodiments, accessibility to the generative artificial intelligence model is limited by the user permissions, wherein the user permissions define a user-specific access level for utilizing the knowledge domain framework. In some embodiments, the indication of the type of the generative artificial intelligence model is associated with one or more types of generative artificial intelligence models available for selection that are filtered based on the user permissions.

In some embodiments, the corpus of selected documents is used to train the generative artificial intelligence model. In some embodiments, the user inputs define how the generative artificial intelligence model is to be trained and developed. In some embodiments, the one or more text submissions indicate one or more organizational needs for the generative artificial intelligence model to be developed. In some embodiments, the one or more responses provide information about development of the generative artificial intelligence model. In some embodiments, the corpus of selected documents is filtered based on the user permissions. In some embodiments, the type of the generative artificial intelligence model that can be selected is trained by only using the corpus of selected documents available based on the user permissions. In some embodiments, the corpus of selected documents includes information about entity policies and procedures. In some embodiments, the corpus of selected documents establish limitations for how the generative artificial intelligence model are permitted be used. In some embodiments, the one or more responses to the one or more text submissions are generated by using natural language understanding and natural language generation functionalities of a chatbot. In some embodiments, the desired knowledge domain is maintained via a backend system of a business entity associated with the corpus of selected documents.

An application program may be deployed by providing computer infrastructure operable to perform one or more embodiments disclosed herein by integrating computer readable code into a computing system thereby performing the computer-implemented methods disclosed herein.

Although various computing environments are described above, these are only examples that can be used to incorporate and use one or more embodiments. Many variations are possible.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to explain the principles of one or more aspects of the invention and the practical application thereof, and to enable others of ordinary skill in the art to understand one or more aspects of the invention for various embodiments with various modifications as are suited to the particular use contemplated.

It is to be noted that various terms used herein such as “Linux®”, “Windows®”, “macOS®”, “iOS®”, “Android®”, and the like may be subject to trademark rights in various jurisdictions throughout the world and are used here only in reference to the products or services properly denominated by the marks to the extent that such trademark rights may exist.

What is claimed is:

1. A computing system filtering access to a domain, the system comprising:
at least one processor;
a communication interface communicatively coupled to the at least one processor; and
a memory device storing executable code that, when executed, causes the at least one processor to:
obtain, via a user interface of a computing device, user credentials to access a knowledge domain framework;
receive access to the knowledge domain framework;
display, via the user interface, prompts facilitating inputs to the knowledge domain framework, the prompts being regulated based on user permissions, the inputs including information to establish a desired knowledge domain, the desired knowledge domain including a corpus of selected documents;
receive, via the user interface, an indication of a type of a generative artificial intelligence model to be developed;
display, via the user interface, a prompt template for receiving user inputs and providing generative outputs;
receive, via the displayed prompt template, one or more text submissions and transmit the one or more text submissions to a chatbot associated with the knowledge domain framework; and
receive, based the one or more text submissions, one or more responses to the one or more text submissions.

2. The computing system of claim 1, wherein the information to establish the desired knowledge domain includes a submission of the corpus of selected documents.

3. The computing system of claim 1, wherein the information to establish the desired knowledge domain includes a selection of previously stored documents, the previously stored documents including the corpus of selected documents.

4. The computing system of claim 1, wherein the chatbot generates the one or more responses by utilizing retrieval-augmented interactions leveraging a large language model.

5. The computing system of claim 1, wherein the user permissions provide role-based access control that defines guardrails that include controls for performing the regulating the prompts for ethics, security, and compliance purposes.

6. The computing system of claim 1, wherein the indication of the type of the generative artificial intelligence model to be developed initiates establishing API connections for the generative artificial intelligence model for use via the prompt template.

7. The computing system of claim 1, wherein accessibility to the generative artificial intelligence model is limited by the user permissions, wherein the user permissions define a user-specific access level for utilizing the knowledge domain framework.

8. The computing system of claim 1, wherein the indication of the type of the generative artificial intelligence model is associated with one or more types of generative artificial intelligence models available for selection that are filtered based on the user permissions.

9. The computing system of claim 1, wherein the corpus of selected documents is used to train the generative artificial intelligence model.

10. The computing system of claim 1, wherein the user inputs define how the generative artificial intelligence model is to be trained and developed.

11. The computing system of claim 1, wherein the one or more text submissions indicate one or more organizational needs for the generative artificial intelligence model to be developed.

12. The computing system of claim 1, wherein the one or more responses provide information about development of the generative artificial intelligence model.

13. The computing system of claim 1, wherein the corpus of selected documents is filtered based on the user permissions.

14. The computing system of claim 1, wherein the type of the generative artificial intelligence model that can be selected is trained by only using the corpus of selected documents available based on the user permissions.

15. The computing system of claim 1, wherein the corpus of selected documents includes information about entity policies and procedures.

16. The computing system of claim 1, wherein the corpus of selected documents establish limitations for how the generative artificial intelligence model are permitted be used.

17. The computing system of claim 1, wherein the one or more responses to the one or more text submissions are generated by using natural language understanding and natural language generation functionalities of a chatbot.

18. The computing system of claim 1, wherein the desired knowledge domain is maintained via a backend system of a business entity associated with the corpus of selected documents.

19. A non-transitory computer-readable storage medium the computer-readable storage medium including instructions that when executed by a processor, cause the processor to:
obtain, via a user interface of a computing device, user credentials to access a knowledge domain framework;
receive access to the knowledge domain framework;
display, via the user interface, prompts facilitating inputs to the knowledge domain framework, the prompts being regulated based on user permissions, the inputs including information to establish a desired knowledge domain, the desired knowledge domain including a corpus of selected documents;
receive, via the user interface, an indication of a type of a generative artificial intelligence model to be developed;
display, via the user interface, a prompt template for receiving user inputs and providing generative outputs;
receive, via the displayed prompt template, one or more text submissions and transmit the one or more text submissions to a chatbot associated with the knowledge domain framework; and
receive, based the one or more text submissions, one or more responses to the one or more text submissions.

20. A computer-implemented method, comprising:
obtaining, via a user interface of a computing device, user credentials to access a knowledge domain framework;
receiving access to the knowledge domain framework;
displaying, via the user interface, prompts facilitating inputs to the knowledge domain framework, the prompts being regulated based on user permissions, the inputs including information to establish a desired knowledge domain, the desired knowledge domain including a corpus of selected documents;
receiving, via the user interface, an indication of a type of a generative artificial intelligence model to be developed;
displaying, via the user interface, a prompt template for receiving user inputs and providing generative outputs;
receiving, via the displayed prompt template, one or more text submissions and transmit the one or more text submissions to a chatbot associated with the knowledge domain framework; and
receiving, based the one or more text submissions, one or more responses to the one or more text submissions.
